(19) United States
(12) Patent Application Publication
(10) Pub. No.: US 2021/0073959 A1
(43) Pub. Date: Mar. 11, 2021

(54) METHOD AND SYSTEM FOR IMAGING AND IMAGE PROCESSING

(71) Applicant: Ramot at Tel-Aviv University Ltd., Tel-Aviv (IL)

(72) Inventors: Shay ELMALEM, Tel Aviv (IL); Raja GIRYES, Tel Aviv (IL); Harel HAIM, Tel Aviv (IL); Alexander BRONSTEIN, Tel Aviv (IL); Emanuel MAROM, Tel Aviv (IL)

(73) Assignee: Ramot at Tel-Aviv University Ltd., Tel-Aviv (IL)

(21) Appl. No.: 16/952,184

(22) Filed: Nov. 19, 2020

Related U.S. Application Data
(63) Continuation of application No. PCT/IL2019/050582, filed on May 22, 2019.
(60) Provisional application No. 62/674,724, filed on May 22, 2018.

(51) Int. Cl. G06T 5/30; G06T 5/00; G06T 7/50; G06T 19/00; G06N 3/08

(52) U.S. Cl. CPC G06T 5/30; G06T 5/003; G06T 7/50; G06T 2207/20081; G06N 3/084; G06T 2207/20084; G06T 19/006

(57) ABSTRACT

A method of designing an element for the manipulation of waves, comprises: accessing a computer readable medium storing a machine learning procedure, having a plurality of learnable weight parameters. A first plurality of the weight parameters corresponds to the element, and a second plurality of the weight parameters correspond to an image processing. The method comprises accessing a computer readable medium storing training imaging data, and training the machine learning procedure on the training imaging data, so as to obtain values for at least the first plurality of the weight parameters.

### RELATED APPLICATIONS

This application is a US Continuation of PCT Patent Application No. PCT/IL2019/050582 having international filing date of May 22, 2019 which claims the benefit of priority under 35 USC § 119(e) of U.S. Provisional Patent Application No. 62/674,724 filed on May 22, 2018. The contents of the above applications are all incorporated by reference as if fully set forth herein in their entirety.

The project leading to this application has received funding from the European Research Council (ERC) under the European Union's Horizon 2020 research and innovation programme (grant agreement No. 757497).

### FIELD AND BACKGROUND OF THE INVENTION

The present invention, in some embodiments thereof, relates to wave manipulation and, more particularly, but not exclusively, to a method and a system for imaging and image processing. Some embodiments of the present invention relate to a technique for co-designing of a hardware element for manipulating a wave and an image processing technique.

Digital cameras are widely used due to high quality and low cost CMOS technology and the increasing popularity of social network. The demand for high resolution and quality cameras, specifically for smart phones, led to a competitive market that constantly tries to create a better camera.

Digital image quality is determined by the imaging system properties and focal plane array sensor. With the increase in pixel number and density, the imaging system resolution is bound now mostly by optical system limitation. The limited volume in smart phones makes it very difficult to improve the image quality by optical solutions and therefore most of the advancements in recent years were software related.

“Computational imaging” is a technique in which some changes are imposed during the image acquisition stage, resulting in an output that is not necessarily the best optical image for a human observer. Yet, the follow-up processing takes advantage of the known changes in the acquisition process in order to generate an improved image or to extract additional information from it (such as depth, different viewpoints, motion data etc.) with a quality that is better than the capabilities of the system used during the image acquisition stage absent the imposed changes.

International Publication No. WO2015/189845 discloses a method of imaging, which comprises capturing an image of a scene by an imaging device having an optical mask that optically decomposes the image into a plurality of channels, each may be characterized by different depth-dependence of a spatial frequency response of the imaging device. A computer readable medium storing an in-focus dictionary and an out-of-focus dictionary is accessed, and one or more sparse representations of the decomposed image is calculated over the dictionaries.

### SUMMARY OF THE INVENTION

According to an aspect of some embodiments of the present invention there is provided a method of designing an element for the manipulation of waves. The method comprises: accessing a computer readable medium storing a machine learning procedure, having a plurality of learnable weight parameters, wherein a first plurality of the weight parameters corresponds to the element, and a second plurality of the weight parameters correspond to an image processing; accessing a computer readable medium storing training imaging data; training the machine learning procedure on the training imaging data, so as to obtain values for at least the first plurality of the weight parameters.

According to some embodiments of the invention the element is a phase mask having a ring pattern, and wherein the first plurality of the weight parameters comprises a radius parameter and a phase-related parameter.

According to some embodiments of the invention the training comprises using backpropagation.

According to some embodiments of the invention the backpropagation comprises calculation of derivatives of a point spread function (PSF) with respect to each of the first plurality of the weight parameters.

According to some embodiments of the invention the training comprises training the machine learning procedure to focus an image.

According to some embodiments of the invention the machine learning procedure comprises a convolutional neural network (CNN).

According to some embodiments of the invention the CNN comprises an input layer configured for receiving the image and an out-of-focus condition.

According to some embodiments of the invention the CNN comprises a plurality of layers, each characterized by a convolution dilation parameter, and wherein values of the convolution dilation parameters vary gradually and non-monotonically from one layer to another.

According to some embodiments of the invention the CNN comprises a skip connection of the image to an output layer of the CNN, such that the training comprises training the CNN to compute de-blurring corrections to the image without computing the image.

According to some embodiments of the invention the training comprises training the machine learning procedure to generate a depth map of an image.

According to some embodiments of the invention the depth map is based on depth cues introduced by the element.

According to some embodiments of the invention the machine learning procedure comprises a depth estimation network and a multi-resolution network.

According to some embodiments of the invention the depth estimation network comprises a convolutional neural network (CNN).

According to some embodiments of the invention the multi-resolution network comprises a fully convolutional neural network (FCN).

According to an aspect of some embodiments of the present invention there is provided a computer software product. The computer software product comprises a computer-readable medium in which program instructions are stored, wherein the instructions, when read by an image processor, cause the image processor to execute the method as delineated above and optionally and preferably as further detailed below.

According to an aspect of some embodiments of the present invention there is provided a method of fabricating an element for manipulating waves. The method comprises, executing the method the method as delineated above and optionally and preferably as further detailed below, and fabricating the element according to the first plurality of the weight parameters.

According to an aspect of some embodiments of the present invention there is provided an element producible by the method the method as delineated above and optionally and preferably as further detailed below. According to an aspect of some embodiments of the present invention there is provided an imaging system, comprising the produced element.

According to an aspect of some embodiments of the present invention the imaging system is selected from the group consisting of a cellular phone, a smartphone, a tablet device, a mobile digital camera, a wearable camera, a personal computer, a laptop, a portable media player, a portable gaming device, a portable digital assistant device, a drone, and a portable navigation device.

According to an aspect of some embodiments of the present invention there is provided a method of imaging. The method comprises: capturing an image of a scene using an imaging device having a lens and an optical mask placed in front of the lens. The optical mask comprises the produced element; and processing the image using an image processor to de-blur the image and/or to generate a depth map of the image.

According to some embodiments of the invention the processing is by a trained machine learning procedure.

According to some embodiments of the invention the processing is by a procedure selected from the group consisting of sparse representation, blind deconvolution, and clustering.

According to some embodiments of the method is executed for providing augmented reality or virtual reality.

According to some embodiments of the invention the scene is a production or fabrication line of a product.

According to some embodiments of the invention the scene is an agricultural scene.

According to some embodiments of the invention the scene comprises an organ of a living subject.

According to some embodiments of the invention the imaging device comprises a microscope.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram describing a method for designing an element for manipulating a wave, according to some embodiments of the present invention.

FIG. 2 is a flowchart diagram illustrating a method suitable for imaging a scene, according to some embodiments of the present invention.

FIG. 3 is a schematic illustration of illustrates an imaging system, according to some embodiments of the present invention.

FIG. 4 illustrates a system according to some embodiments of the present invention that consists of a phase coded aperture lens followed by a convolutional neural network (CNN) that provides an all-in-focus image. The parameters of the phase mask and the weights of the CNN are jointly trained in an end-to-end fashion, which leads to an improved performance compared to optimizing each part alone.

FIGS. 5A-F show an add-on phase-mask pattern contains a phase ring (red). The phase ring parameters are optimized along with the CNN training. When incorporated in the aperture stop of a lens, the phase mask modulates the PSF/MTF of the imaging system for the different colors in the various defocus conditions.

FIG. 6 is a schematic illustration of an all-in-focus CNN architecture: The full architecture being trained, including the optical imaging layer whose inputs are both the image and the current defocus condition. After the training phase, the corresponding learned phase mask is fabricated and incorporated in the lens, and only the ‘conventional’ CNN block is being inferred (yellow colored). ‘d’ stands for dilation parameter in the CONV layers.

FIGS. 7A-J show simulation results obtained in experiments performed according to some embodiments of the present invention.

FIGS. 8A-D show experimental images captured in experiments performed according to some embodiments of the present invention.

FIGS. 9A-D show examples with different depth from FIG. 8A, in experiments performed according to some embodiments of the present invention.

FIGS. 10A-D show examples with different depth from FIG. 8B in experiments performed according to some embodiments of the present invention.

FIGS. 11A-D show examples with different depth from FIG. 8C in experiments performed according to some embodiments of the present invention.

FIGS. 12A-D show examples with different depth from FIG. 8D in experiments performed according to some embodiments of the present invention.

FIGS. 13A and 13B show spatial frequency response and color channel separation. FIG. 13A shows optical system response to normalized spatial frequency for different values of the defocus parameter ψ. FIG. 13B shows comparison between contrast levels for a single normalized spatial frequency (0.25) as a function of w with clear aperture (dotted) and a trained phase mask (solid).

FIG. 14 is a schematic illustration of a neural network architecture for depth estimation CNN. Spatial dimension reduction is achieved by convolution stride instead of pooling layers. Every CONV block is followed by BN-ReLU layer (not shown in this figure).

FIGS. 15A and 15B are schematic illustrations of aperture phase coding mask. FIG. 15A shows 3D illustration of the optimal three-ring mask, and FIG. 15B shows cross-section of the mask. The area marked in black acts as a circular pupil.

FIG. 16 is a schematic illustration of a network architecture for depth estimation FCN. A depth estimation network (see FIG. 14) is wrapped in a deconvolution framework to provide depth estimation map equal to the input image size.

FIG. 17A shows confusion matrix for the depth segmentation FCN validation set.

FIG. 17B shows MAPE as a function of the focus point using a continuous net.

FIGS. 18A-D show depth estimation results on simulated image from the ‘Agent’ dataset. FIG. 18A shows original input image (the actual input image used in the net was the raw version of the presented image), FIG. 18B shows continuous ground truth, and FIGS. 18C-D show continuous depth estimation achieved using the L1 loss (FIG. 18C) and the L2 loss (FIG. 18D).

FIGS. 19A-D show additional depth estimation results on simulated scenes from the ‘Agent’ dataset. FIG. 19A shows original input image (the actual input image used in our net was the raw version of the presented image), FIG. 19B shows continuous ground truth, and FIGS. 19C-D show continuous depth estimation achieved by the FCN network of some embodiments of the present invention when trained using the L1 loss (FIG. 19C) and the L2 loss (FIG. 19D).

FIGS. 20A and 20B show 3D face reconstruction, where FIG. 20A shows an input image and FIG. 20B shows the corresponding point cloud map.

FIGS. 21A and 21B are images showing a lab setup used in experiments performed according to some embodiments of the present invention. A lens and a phase mask are shown in FIG. 21A, and an indoor scene side view is shown in FIG. 21B.

FIGS. 22A-D show indoor scene depth estimation. FIG. 22A shows the scene and its depth map acquired using Lytro Ilium camera (FIG. 22B), a monocular depth estimation net (FIG. 22C), and the method according to some embodiments of the present invention (FIG. 22D). As each camera has a different field of view, the images were cropped to achieve roughly the same part of the scene. The depth scale for FIG. 22D is from 50 cm (red) to 150 cm (blue). Because the outputs of FIGS. 22B and 22C provide only a relative depth map (and not absolute as in the case of (FIG. 22D), their maps were brought manually to the same scale for visualization purposes.

FIGS. 23A-D show outdoor scenes depth estimation. Depth estimation results for a granulated wall (upper) and grassy slope with flowers (lower) scenes. FIG. 23A shows the scene and its depth map acquired using Lytro Illum camera (FIG. 23B), Liu et al. monocular depth estimation net (FIG. 23C), and the method of the present embodiments (FIG. 23D). As each camera has a different field of view, the images were cropped to achieve roughly the same part of the scene. The depth scale for FIG. 23D is from 75 cm (red) to 175 cm (blue). Because the outputs of FIGS. 23B and 23C provide only a relative depth map (and not absolute as in the case of FIG. 23D), their maps were brought manually to the same scale for visualization purposes.

FIGS. 24A-D show additional examples for outdoor scenes depth estimation outdoor scenes depth estimation. The depth scale for the upper two rows of FIG. 24D is from 50 cm (red) to 450 cm (blue), and the depth scale for the lower two rows of FIG. 24D is from 50 cm (red) to 150 cm (blue). See caption of FIGS. 22A-D for further details.

### DESCRIPTION OF SPECIFIC EMBODIMENTS OF THE INVENTION

The present invention, in some embodiments thereof, relates to wave manipulation and, more particularly, but not exclusively, to a method and a system for imaging and image processing. Some embodiments of the present invention relate to a technique for co-designing of a hardware element for manipulating a wave and an image processing technique.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

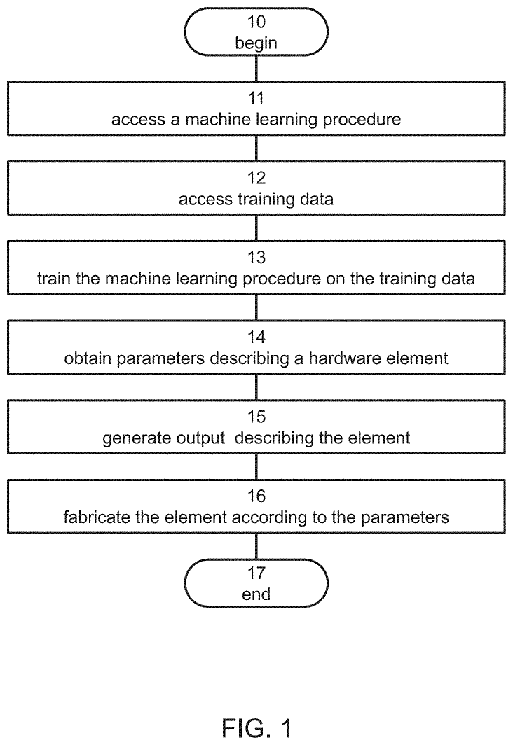

FIG. 1 is a flowchart diagram describing a method for designing a hardware for manipulating a wave, according to some embodiments of the present invention.

At least part of the processing operations described herein can be implemented by an image processor, e.g., a dedicated circuitry or a general purpose computer, configured for receiving data and executing the operations described below. At least part of the processing operations described herein can be implemented by a data processor of a mobile device, such as, but not limited to, a smartphone, a tablet, a smartwatch and the like, supplemented by software app programed to receive data and execute processing operations. At least part of the processing operations can be implemented by a cloud-computing facility at a remote location.

Processing operations described herein may be performed by means of processer circuit, such as a DSP, microcontroller, FPGA, ASIC, etc., or any other conventional and/or dedicated computing system.

The processing operations of the present embodiments can be embodied in many forms. For example, they can be embodied in on a tangible medium such as a computer for performing the operations. They can be embodied on a computer readable medium, comprising computer readable instructions for carrying out the method operations. They can also be embodied in electronic device having digital computer capabilities arranged to run the computer program on the tangible medium or execute the instruction on a computer readable medium.

Computer programs implementing the method according to some embodiments of this invention can commonly be distributed to users on a distribution medium such as, but not limited to, CD-ROM, flash memory devices, flash drives, or, in some embodiments, drives accessible by means of network communication, over the internet (e.g., within a cloud environment), or over a cellular network. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. Computer programs implementing the method according to some embodiments of this invention can also be executed by one or more data processors that belong to a cloud computing environment. All these operations are well-known to those skilled in the art of computer systems. Data used and/or provided by the method of the present embodiments can be transmitted by means of network communication, over the internet, over a cellular network or over any type of network, suitable for data transmission.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The type of a hardware element to be designed depends on the type of the wave it is to manipulate. For example, when it is desired to manipulate an electromagnetic wave (e.g., an optical wave, a millimeter wave, etc.), for example, for the purpose of imaging, the hardware element is an element that is capable of manipulating electromagnetic waves. When it is desired to manipulate a mechanical wave (e.g., an acoustic wave, an ultrasound wave, etc.), for example, for the purpose of acoustical imaging, the hardware element is an element that is capable of manipulating a mechanical wave.

As used herein “manipulation” refers to one or more of: refraction, diffraction, reflection, redirection, focusing, absorption and transmission.

In some embodiments of the present invention the hardware element to be designed is an optical element.

While the embodiments below are described with a particular emphasis to an optical element, it is to be understood that the other types of wave manipulating elements are also contemplated.

In some embodiments of the present invention the optical element is an optical mask that decomposes light passing therethrough into a plurality of channels. Each of the channels is typically characterized by a different range of effective depth-of-field (DOF). The DOF is typically parameterized using a parameter known as the defocus parameter Ψ. A defocus parameter is a well-known quantity and is defined mathematically in the Examples section that follows.

In typical imaging systems, the defocus parameter is, in absolute value, within the range 0 to 6 radians, but other ranges, e.g., from about −4 to about 10, are also envisioned. The optical element is typically designed for use as an add-on to an imaging device having a lens, in a manner that the optical element is placed in front or behind the lens or within in a lens assembly, e.g., between two lenses of the lens assembly. The imaging device can be configured for stills imaging, video imaging, two-dimensional imaging, three-dimensional imaging, and/or high dynamic range imaging. The imaging device can serve as a component in an imaging system that comprises two or more imaging devices and be configured to capture stereoscopic images. In these embodiments, one or more of the imaging devices can be operatively associated with the optical element to be designed, and the method can optionally and preferably be executed for designing each of the optical elements of the imaging device. Further contemplated are embodiments in which the imaging device includes an array of image sensors. In these embodiments, one or more of the image sensors can include or be operatively associated with the optical element to be designed, and the method can optionally and preferably be executed for designing each of the optical elements of the imaging device.

In some embodiments of the present invention, each of the channels is characterized by a different depth-dependence of a spatial frequency response of the imaging device used for captured the image. The spatial frequency response can be expressed, for example, as an Optical Transfer Function (OTF).

In various exemplary embodiments of the invention the channels are defined according to the wavelengths of the light arriving from the scene. In these embodiments, each channel corresponds to a different wavelength range of the light. As will be appreciated by one of ordinarily skilled in the art, different wavelength ranges correspond to different depth-of-field ranges and to different depth-dependence of the spatial frequency response. A representative example of a set of channels suitable for the present embodiments is a red channel, corresponding to red light (e.g., light having a spectrum having an apex at a wavelength of about 620-680 nm), a green channel, corresponding to green light (spectrum having an apex at a wavelength of from about 520 to about 580 nm), and a blue channel, corresponding to blue light (spectrum having an apex at a wavelength of from about 420 to about 500 nm). Such a set of channels is referred to herein collectively as RGB channels.

The optical mask can be an RGB phase mask selected for optically delivering different exhibited phase shifts for different wavelength components of the light. For example, the mask can generate phase-shifts for red light, for green light and for blue light. In some embodiments of the present invention the phase mask has one or more concentric rings that may form a grove and/or relief pattern on a transparent mask substrate. Each ring preferably exhibits a phase-shift that is different to the phase-shift of the remaining mask regions. The mask can be a binary amplitude phase mask, but non-binary amplitude phase masks are also contemplated.

The method begins at 10 and optionally and preferably continues to 11 at which a computer readable medium storing a machine learning procedure is accessed. The machine learning procedure has a plurality of learnable weight parameters, wherein a first plurality of the weight parameters corresponds to the optical element to be designed. For example, when the optical element is a phase mask having a ring pattern, the first plurality of weight parameters can comprise one or more radius parameters and a phase-related parameter. The radius parameters can include the inner and outer radii of the ring pattern, and the phase-related parameter can include the phase acquired by the light passing through the mask, or a depth of the groove or the relief.

A second plurality of the weight parameters optionally and preferably correspond to an image processing procedure.

Herein, “image processing” encompasses both sets of computer-implement operations in which the output is an image, and sets of computer-implement operations in which the output describes features that relate to the input image, but does not necessarily includes the image itself. The latter sets of computer-implement operations are oftentimes referred to in the literature as computer vision operation.

The present embodiments contemplate many types of machine learning procedures. Representative examples for a machine learning procedure suitable for the present embodiments include, without limitation, a neural network, e.g., a convolutional neural network (CNN) or a fully CNN (FCN), a support vector machine procedure, a k-nearest neighbors procedure, a clustering procedure, a linear modeling procedure, a decision tree learning procedure, an ensemble learning procedure, a procedure based on a probabilistic model, a procedure based on a graphical model, a Bayesian network procedure, and an association rule learning procedure.

In some preferred embodiments the machine learning procedure comprises a CNN, and in some preferred embodiments the machine learning procedure comprises an FCN. Preferred machine learning procedures that are based on CNN and FCN are detailed in the Examples section that follows.

In some preferred embodiments the machine learning procedure comprises an artificial neural network. Artificial neural networks are a class of computer implemented techniques that are based on a concept of inter-connected “artificial neurons,” also abbreviated “neurons.” In a typical artificial neural network, the artificial neurons contain data values, each of which affects the value of a connected artificial neuron according to connections with pre-defined strengths, and whether the sum of connections to each particular artificial neuron meets a pre-defined threshold. By determining proper connection strengths and threshold values (a process referred to as training), an artificial neural network can achieve efficient recognition of rules in the data. The artificial neurons are oftentimes grouped into interconnected layers, the number of which is referred to as the depth of the artificial neural network. Each layer of the network may have differing numbers of artificial neurons, and these may or may not be related to particular qualities of the input data. Some layers or sets of interconnected layers of an artificial neural network may operate independently from each other. Such layers or sets of interconnected layers are referred to as parallel layers or parallel sets of interconnected layers.

The basic unit of an artificial neural network is therefore the artificial neuron. It typically performs a scalar product of its input (a vector x) and a weight vector w. The input is given, while the weights are learned during the training phase and are held fixed during the validation or the testing phase. Bias may be introduced to the computation by concatenating a fixed value of 1 to the input vector creating a slightly longer input vector x, and increasing the dimensionality of w by one. The scalar product is typically followed by a non-linear activation function σ:R→R, and the neuron thus computes the value σ(w^{T}x). Many types of activation functions that are known in the art, can be used in the artificial neural network of the present embodiments, including, without limitation, Binary step, Soft step, TanH, ArcTan, Softsign, Inverse square root unit (ISRU), Rectified linear unit (ReLU), Leaky rectified linear unit, Parameteric rectified linear unit (PReLU), Randomized leaky rectified linear unit (RReLU), Exponential linear unit (ELU), Scaled exponential linear unit (SELU), S-shaped rectified linear activation unit (SReLU), Inverse square root linear unit (ISRLU), Adaptive piecewise linear (APL), SoftPlus, Bent identity, SoftExponential, Sinusoid, Sinc, Gaussian, Softmax and Maxout. In some embodiments of the present invention ReLU or a variant thereof (e.g., PReLU, RReLU, SReLU) is used.

A layered neural network architecture (V,E,σ) is typically defined by a set V of layers, a set E of directed edges and the activation function σ. In addition, a neural network of a certain architecture is defined by a weight function w:E→R.

In one implementation, called a fully-connected artificial neural network, every neuron of layer Vᵢ is connected to every neuron of layer Vᵢ₊₁. In other words, the input of every neuron in layer Vᵢ₊₁ consists of a combination (e.g., a sum) of the activation values (the values after the activation function) of all the neurons in the previous layer Vᵢ. This combination can be compared to a bias, or threshold. If the value exceeds the threshold for a particular neuron, that neuron can hold a positive value which can be used as input to neurons in the next layer of neurons.

The computation of activation values continues through the various layers of the neural network, until it reaches a final layer, which is oftentimes called the output layer. Typically some concatenation of neuron values is executed before the output layer. At this point, the output of the neural network routine can be extracted from the values in the output layer. In the present embodiments, the output of the neural network describes the shape of the nanostructure. Typically the output can be a vector of numbers characterizing lengths, directions and/or angles describing various two- or three-dimensional geometrical features that collectively form the shape of the nanostructure.

In some preferred embodiments the machine learning procedure comprises a CNN, and in some preferred embodiments the machine learning procedure comprises an FCN. A CNN is different from fully-connected neural networks in that in a CNN operates by associating an array of values with each neuron, rather than a single value. The transformation of a neuron value for the subsequent layer is generalized from multiplication to convolution. An FCN is similar to CNN except that CNN may include fully connected layers (for example, at the end of the network), while an FCN is typically devoid of fully connected layers. Preferred machine learning procedures that are based on CNN and FCN are detailed in the Examples section that follows.

The method proceeds to 12 at which a computer readable medium storing training imaging data is accessed. The training imaging data typically comprise a plurality of images, preferably all-in-focus images. In some embodiments of the present invention each image in the training imaging data is associated with a known parameter describing the DOF of the image. For example, the images can be associated with numerical defocus parameter values. In some embodiments of the present invention each image in the training imaging data is associated with, and pixel-wise registered, to a known depth map. Also contemplated, are embodiments in which each image in the training imaging data is associated with a known parameter describing the DOF of the image as well as with a known depth map.

The images in the training data are preferably selected based on the imaging application in which the optical element to be designed is intended to be used. For example, when the optical element is for use in a mobile device (e.g., a cellular phone, a smartphone, a tablet device, a mobile digital camera, a wearable camera, a personal computer, a laptop, a portable media player, a portable gaming device, a portable digital assistant device, a drone, or a portable navigation device), the images in the training data are image of a type that is typically captured using a camera of such a mobile device (e.g., outdoor images, portraits), when the optical element is for use in augmented reality or virtual reality applications, the images in the training data are image of a type that is typically captured in such augmented or virtual reality applications, when the optical element is for use in quality inspection, the training data are image of scenes that include a production or fabrication line of a product, when the optical element is for use in agriculture, the training data are image of agricultural scenes, when the optical element is for use in medical imaging, the training data are image of organs of living subjects, when the optical element is for use in microscopy, the training data are image captured through a microscope, etc.

The method continues to 13 at which the machine learning procedure is trained on the training imaging data. Preferably, but not necessarily, the machine learning procedure is trained using backpropagation, so as to obtain, at 14, values for the weight parameters that describe the hardware (e.g., optical) element. The backward propagation optionally and preferably calculation of derivatives of a point spread function (PSF) with respect to each of the parameters that describes the optical element. For example, when the parameters include a radius and a phase, the machine learning procedure calculate the derivatives of the PSF with respect to the radius, and the PSF with respect to the phase.

Thus, the machine learning procedure of some of the embodiments has a forward propagation that describes the imaging operation and a backward propagation that describes the optical element through which the image is captured by the imaging device. That is to say, the machine learning procedure is constructed such that during the training phase, images that are associated with additional information (e.g., defocus parameter, depth map) are used by the procedure for determining the parameters of the optical parameter, and when an imaged captured through an optical element that is characterized by those parameters is fed to the machine learning procedure, once trained, the trained machine learning procedure processes the image to improve it.

In some embodiments of the present invention the machine learning procedure is trained so as to allow the procedure to focus an image, once operated, for example, in forward propagation. In these embodiments, the machine learning procedure can comprise a CNN, optionally and preferably a CNN with an input layer that is configured for receiving an image and an out-of-focus condition (e.g., a defocus parameter). One or more layers of the CNN is preferably characterized by a convolution dilation parameter. Preferably, the values of the convolution dilation parameters vary gradually and non-monotonically from one layer to another. For example, the values of the convolution dilation parameters can gradually increase in the forward propagation away from the input layer and then gradually decrease in the forward propagation towards the last layer.

It was found by the inventors that it is more efficient for the CNN to estimate corrections to blurred image, rather than to estimate the corrected image itself. Therefore, according to some embodiments of the present invention the CNN comprises a skip connection of the image to the output layer of the CNN, such that the training comprises training the CNN to compute de-blurring corrections to the image without computing the image itself.

In some embodiments of the present invention the machine learning procedure is trained so as to allow the procedure to generate a depth map of an image, once operated, for example, in forward propagation. The depth map is optionally and preferably calculated by the procedure based on depth cues that are introduced to the image by the optical element. For generating a depth map, the machine learning procedure optionally and preferably comprises a depth estimation network, which is preferably a CNN, and a multi-resolution network, which is preferably an FCN. The depth estimation network can be constructed for estimating depth as a discrete output or a continuous output, as desired.

The method can optionally and preferably proceed to 15 at which an output describing the hardware (e.g., optical) element is generated. For example, the output can include the parameters obtained at 14. The output can be displayed on a display device and/or stored in a computer readable memory. In some embodiments of the present invention the method proceeds to 16 at which a hardware (e.g., optical) element is fabricated according to the parameters obtained at 14. For example, when the hardware element is a phase mask having one or more rings, the rings can be formed in a transparent mask substrate by wet etching, dry etching, deposition, 3D printing, or any other method, where the radius and depth of each ring can be according the parameters obtained at 14.

The method ends at 17.

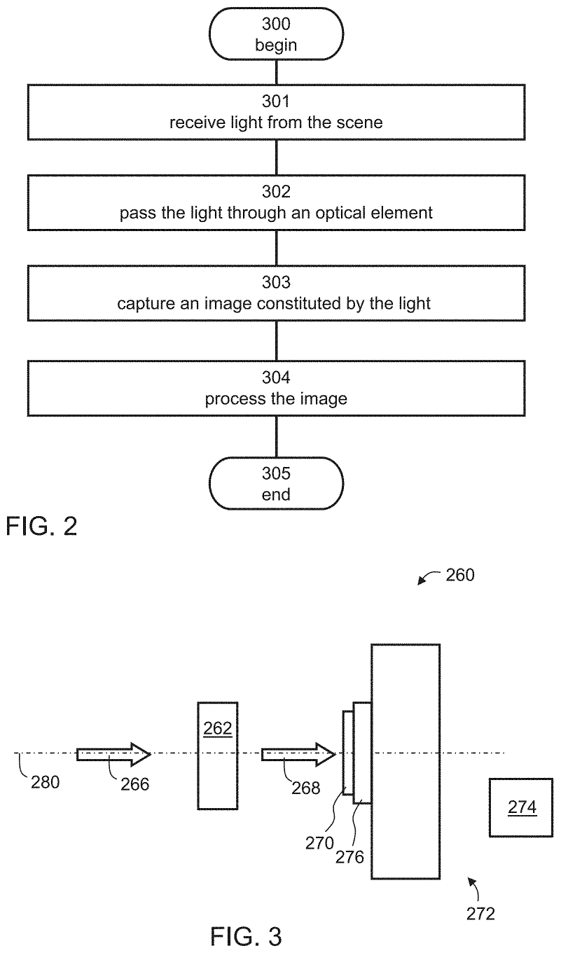

Reference is now made to FIG. 2 which is a flowchart diagram illustrating a method suitable for imaging a scene, according to some embodiments of the present invention. The method begins at 300 and continues to 301 at which light is received from the scene. The method continues to 302 at which the light is passed through an optical element. The optical element can be an element designed and fabricated as further detailed hereinabove. For example, the optical element can be a phase mask that generates a phase shift in the light. The method continues to 303 at which an image constituted by the light is captured. The method continues to 305 at which the image is processed. The processing can be by an image processor configured, for example, to de-blur the image and/or to generate a depth map of the image. The processing can be by a trained machine learning procedure, such as, but not limited to, the machine learning procedure described above, operated, for example, in the forward direction. However, this need not necessarily be the case, since, for some applications, it may not be necessary for the image processor top to apply a machine learning procedure. For example, the processing can be by a procedure selected from the group consisting of sparse representation, blind deconvolution, and clustering.

The method ends at 305.

FIG. 3 illustrates an imaging system 260, according to some embodiments of the present invention. Imaging system 260 can be used for imaging a scene as further detailed hereinabove. Imaging system 260 comprises an imaging device 272 having an entrance pupil 270, a lens or lens assembly 276, and optical element 262, which is preferably the optical element designed and fabricated as further detailed hereinabove. Optical element 262, can be placed for example, on the same optical axis 280 therewith.

While FIG. 3 illustrates optical element 262 as being placed in front of the entrance pupil 270 of imaging system 260, this need not necessarily be the case. For some applications, optical element 262 can placed at entrance pupil 270, behind entrance pupil 270, for example at an exit pupil (not shown) of imaging system 260, or between the entrance pupil and the exit pupil.

When system 260 comprises a single lens, optical element 262, can be placed in front of the lens of system 260, or behind the lens of system 260. When system 260 comprises a lens assembly, optical element 262 is optionally and preferably placed at or at the vicinity of a plane of the aperture stop surface of lens assembly 276, or at or at the vicinity of one of the image planes of the aperture stop surface.

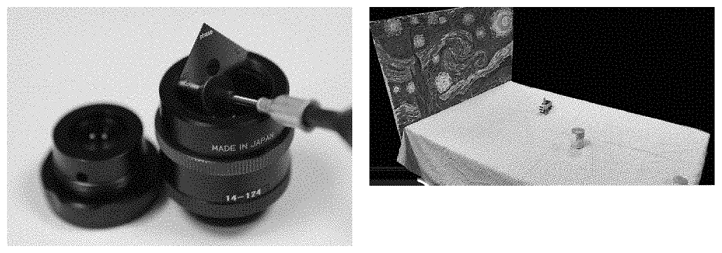

For example, when the aperture stop plane of lens assembly 276 is located within the lens assembly, optical element 262 can be placed at or at the vicinity of entrance pupil 270, which is a plane at which the lenses of lens assembly 276 that are in front of the aperture stop plane create an optical image of the aperture stop plane. Alternatively, optical element 262 can be placed at or at the vicinity of the exit pupil (not shown) of lens assembly 276, which is a plane at which the lenses of lens assembly 276 that are behind the aperture stop plane create an optical image of the aperture stop plane. It is appreciated that such planes can overlap (for example, when one singlet lens of the assembly is the aperture stop). Further, when these are secondary pupils (for example, in cases in which the lens assembly includes many singlet lenses), optical element 262 can be placed at or at the vicinity of one of the secondary pupils. An embodiment in which optical element 262 is placed within the lens assembly is shown in the image of FIG. 21A of the Examples section that follows.

Imaging system 260 can be incorporated, for example, in a portable device, such as, but not limited to, a cellular phone, a smartphone, a tablet device, a mobile digital camera, a wearable camera, a personal computer, a laptop, a portable media player, a portable gaming device, a portable digital assistant device, a drone, and a portable navigation device. Imaging system 260 can alternatively be incorporated in other systems, such as microscopes, non-movable security cameras, etc. Optical element 262 can be used for changing the phase of a light beam, thus generating a phase shift between the phase of the beam at the entry side of element 262 and the phase of the beam at the exit side of element 262. The light beam before entering element 262 is illustrated as a block arrow 266 and the light beam after exiting element 262 is illustrated as a block arrow 268. System 260 can also comprise an image processor 274 configured for processing images captured by device 272 through element 262, as further detailed hereinabove.

Imaging system 260 can be configured to provide any type of imaging known in the art. Representative examples include, without limitation, stills imaging, video imaging, two-dimensional imaging, three-dimensional imaging, and/or high dynamic range imaging. Imaging system 260 can also include more than one imaging devices, for example, to allow system 260 to capture stereoscopic images. In these embodiments, one or more of the imaging devices can include or be operatively associated with optical element 262, wherein the optical elements 262 of different devices can be the same or they can be different from each other, in accordance with the output of the method of the present embodiments.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

Learned Phase Coded Aperture for Depth of Field Extension

Modern consumer electronics market dictates the need for small-scale and high performance cameras. Such designs involve trade-offs between various system parameters. In such trade-offs, Depth Of Field (DOF) rises as an issue many times. Some embodiments of the present invention provide a computational imaging-based technique to overcome DOF limitations. The approach is based on a synergy between a simple phase aperture coding element and a convolutional neural network (CNN). The phase element, designed for DOF extension using color diversity in the imaging system response, causes chromatic variations by creating a different defocus blur for each color channel in the image. The phase mask is designed such that the CNN model is able to restore from the coded image an all-in-focus image easily. This is achieved by using a joint end-to-end training of both the phase element and the CNN parameters using backpropagation. The proposed approach shows superior performance to other methods in simulations as well as in real-world scenes.

Imaging system design has always been a challenge, due to the need of meeting many requirements with relatively few degrees of freedom. Since digital image processing has become an integral part of almost any imaging system, many optical issues can now be solved using signal processing. However, in most cases the design is done separately, i.e., the optical design is done in the traditional way, aiming at the best achievable optical image, and then the digital stage attempts to improve it even more.

A joint design of the optical and signal processing stages may lead to better overall performance. Indeed, such effort is an active research area for many applications, e.g., extended depth of field (EDOF) [E. R. Dowski and W. T. Cathey, “Extended depth of field through wave-front coding,” Appl. Opt. 34, 1859-1866 (1995); O. Cossairt and S. Nayar, “Spectral focal sweep: Extended depth of field from chromatic aberrations,” in “2010 IEEE International Conference on Computational Photography (ICCP),” (2010), pp. 1-8; O. Cossairt, C. Zhou, and S. Nayar, “Diffusion coded photography for extended depth of field,” in “ACM SIGGRAPH 2010 Papers,” (ACM, New York, N.Y., USA, 2010), SIGGRAPH '10, pp. 31:1-31:10; A. Levin, R. Fergus, F. Durand, and W. T. Freeman, “Image and depth from a conventional camera with a coded aperture,” in “ACM SIGGRAPH 2007 Papers,” (ACM, New York, N.Y., USA, 2007), SIGGRAPH '07; F. Zhou, R. Ye, G. Li, H. Zhang, and D. Wang, “Optimized circularly symmetric phase mask to extend the depth of focus,” J. Opt. Soc. Am. A 26, 1889-1895 (2009); C. J. R. Sheppard, “Binary phase filters with a maximally-flat response,” Opt. Lett. 36, 1386-1388 (2011); C. J. Sheppard and S. Mehta, “Three-level filter for increased depth of focus and bessel beam generation,” Opt. Express 20, 27212-27221 (2012)], image deblurring both due to optical blur [C. Zhou, S. Lin, and S. K. Nayar, “Coded aperture pairs for depth from defocus and defocus deblurring,” Int. J. Comput. Vis. 93, 53-72 (2011)] and motion blur [R. Raskar, A. Agrawal, and J. Tumblin, “Coded exposure photography: Motion deblurring using fluttered shutter,” in “ACM SIGGRAPH 2006 Papers,” (ACM, New York, N.Y., USA, 2006), SIGGRAPH '06, pp. 795-804], high dynamic range [G. Petschnigg, R. Szeliski, M. Agrawala, M. Cohen, H. Hoppe, and K. Toyama, “Digital photography with flash and no-flash image pairs,” in “ACM SIGGRAPH 2004 Papers,” (ACM, New York, N.Y., USA, 2004), SIGGRAPH '04, pp. 664-672], depth estimation [C. Zhou, S. Lin, and S. K. Nayar supra; H. Haim, A. Bronstein, and E. Marom, “Computational multi-focus imaging combining sparse model with color dependent phase mask,” Opt. Express 23, 24547-24556 (2015)], light field photography [R. Ng, M. Levoy, M. Brédif, G. Duval, M. Horowitz, and P. Hanrahan, “Light field photography with a hand-held plenoptic camera,” (2005)].

In the vast majority of computational imaging processes, the optics and post-processing are designed separately, to be adapted to each other, and not in an end-to-end fashion.

In recent years, deep learning (DL) methods ignited a revolution across many domains including signal processing. Instead of attempts to explicitly model a signal, and utilize this model to process it, DL methods are used to model the signal implicitly, by learning its structure and features from labeled datasets of enormous size. Such methods have been successfully used for almost all image processing tasks including denoising [H. C. Burger, C. J. Schuler, and S. Harmeling, “Image denoising: Can plain neural networks compete with bm3d?” in “2012 IEEE Conference on Computer Vision and Pattern Recognition,” (2012), pp. 2392-2399; S. Lefkimmiatis, “Non-local color image denoising with convolutional neural networks,” in “The IEEE Conference on Computer Vision and Pattern Recognition (CVPR),” (2017); T. Remez, O. Litany, R. Giryes, and A. M. Bronstein, “Deep class-aware image denoising,” in “International Conference on Image Processing (ICIP),” (2017), pp. 138-142], demosaicing [M. Gharbi, G. Chaurasia, S. Paris, and F. Durand, “Deep joint demosaicking and denoising,” ACM Trans. Graph. 35, 191:1-191:12 (2016).], deblurring [K. Zhang, W. Zuo, S. Gu, and L. Zhang, “Learning deep cnn denoiser prior for image restoration,” in “The IEEE Conference on Computer Vision and Pattern Recognition (CVPR),” (2017)], high dynamic range [N. K. Kalantari and R. Ramamoorthi, “Deep high dynamic range imaging of dynamic scenes,” ACM Trans. Graph. 36, 144:1-144:12 (2017)]. The main innovation in the DL approach is that inverse problems are solved by an end-to-end learning of a function that performs the inversion operation, without any explicit signal model.

DOF imposes limitations in many optical designs. To ease these limitations, several computational imaging approaches have been investigated. Among the first ones, one may name the method of Dowski and Cathey [supra], where a cubic phase mask is incorporated in the imaging system exit pupil. This mask is designed to manipulate the lens point spread function (PSF) to be depth invariant for an extended DOF. The resulting PSF is relatively wide, and therefore the modulation transfer function (MTF) of the system is quite narrow. Images acquired with such a lens are uniformly blurred with the same PSF, and therefore can be easily restored using a non-blind deconvolution method.

Similar approaches avoid the use of the cubic phase mask (which is not circularly symmetric and therefore requires complex fabrication), and achieve depth invariant PSF using a random diffuser [O. Cossairt, C. Zhou, and S. Nayar supra; E. E. García-Guerrero, E. R. Méndez, H. M. Escamilla, T. A. Leskova, and A. A. Maradudin, “Design and fabrication of random phase diffusers for extending the depth of focus,” Opt. Express 15, 910-923 (2007)] or by enhancing chromatic aberrations (albeit still producing a monochrome image) [O. Cossairt and S. Nayar supra]. The limitation of these methods is that the intermediate optical image quality is relatively poor (due to the narrow MTF), resulting in noise amplification in the deconvolution step.

Other approaches [A. Levin, R. Fergus, F. Durand, and W. T. Freeman supra; F. Guichard, H.-P. Nguyen, R. TessiÃĺres, M. Pyanet, I. Tarchouna, and F. Cao, “Extended depth-of-field using sharpness transport across color channels,” in “Proc. SPIE,”, vol. 7250 (2009), vol. 7250, pp. 7250-7250-12] have tried to create a PSF with a strong and controlled depth variance, using it as a prior for the image deblurring step. In Levin et al., the PSF is encoded using an amplitude mask that blocks 50% of the input light, which makes it impractical in low-light applications. In Guichard et al., the depth dependent PSF is achieved by enhancing axial chromatic aberrations, and then ‘transferring’ resolution from one color channel to another (using a RGB sensor). While this method is light efficient, its design imposes two limitations: (i) its production requires custom and non-standard optical design; and (ii) by enhancing axial chromatic aberrations, lateral chromatic aberrations are usually also enhanced.

Haim, Bronstein and Marom supra suggested to achieve a chromatic and depth dependent PSF using a simple diffractive binary phase-mask element having a concentric ring pattern. Such a mask changes the PSF differently for each color channel, thus achieving color diversity in the imaging system response. The all-in-focus image is restored by a sparse-coding based algorithm with dictionaries that incorporate the encoded PSFs response. This method achieves good results, but with relatively high computational cost (due to the sparse coding step).

Note that in all mentioned approaches, the optics and the processing algorithm are designed separately. Thus, the designer has to find a balance between many system parameters: aperture size, number of optical elements, exposure time, pixel size, sensor sensitivity and many other factors. This makes the pursuit of the “correct” parameters tradeoff, which leads to the desired EDOF, harder.

This Example describes an end-to-end design approach for EDOF imaging. A method for DOF extension that can be added to an existing optical design, and as such provides an additional degree of freedom to the designer, is presented. The solution is based on a simple binary phase mask, incorporated in the imaging system exit pupil (or any of its conjugate optical surfaces). The mask is composed of a ring/s pattern, whereby each ring introduces a different phase-shift to the wavefront emerging from the scene; the resultant image is aperture coded.

Differently than Haim, Bronstein and Marom, where sparse coding is used, the image is fed to a CNN, which restores the all-in-focus image. Moreover, while in Haim, Bronstein and Marom the mask is manually designed, in this work the imaging step is modeled as a layer in the CNN, where its weights are the phase mask parameters (ring radii and phase). This leads to an end-to-end training of the whole system; both the optics and the computational CNN layers are trained all together, for a true holistic design of the system. Such a design eliminates the need to determine an optical criterion for the mask design step. In the presented design approach, the optical imaging step and the reconstruction method are jointly learned together. This leads to improved performance of the system as a whole (and not to each part, as happens when optimizing each of them separately).

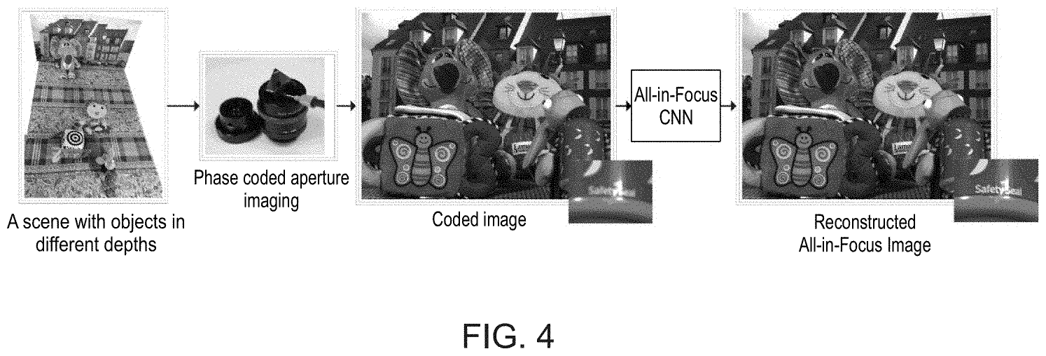

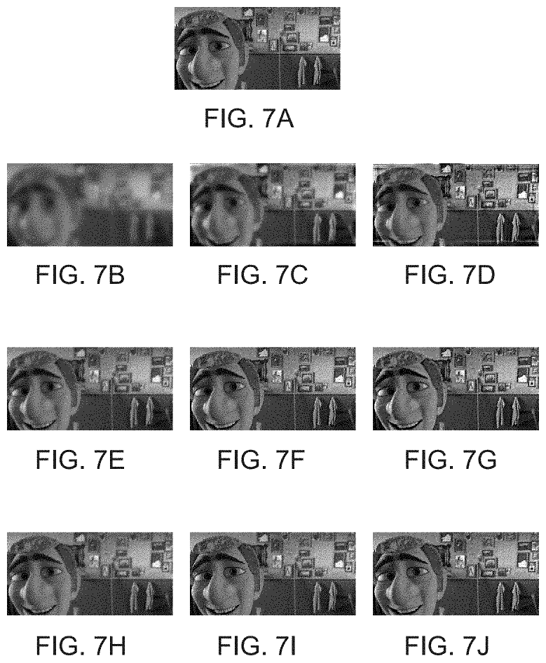

FIG. 4 presents a scheme of the system, and FIGS. 7A-J demonstrates the advantage of training the mask.

Different deep end-to-end designs of imaging systems using backpropagation have been presented before, for other image processing or computer vision tasks, such as demosaicking [A. Chakrabarti, “Learning sensor multiplexing design through back-propagation,” in “Advances in Neural Information Processing Systems 29,” D. D. Lee, M. Sugiyama, U. V. Luxburg, I. Guyon, and R. Garnett, eds. (Curran Associates, Inc., 2016), pp. 3081-3089], depth estimation, object classification [H. G. Chen, S. Jayasuriya, J. Yang, J. Stephen, S. Sivaramakrishnan, A. Veeraraghavan, and A. C. Molnar, “Asp vision: Optically computing the first layer of convolutional neural networks using angle sensitive pixels,” 2016 IEEE Conf. on Comput. Vis. Pattern Recognit. (CVPR) pp. 903-912 (2016); G. Satat, M. Tancik, O. Gupta, B. Heshmat, and R. Raskar, “Object classification through scattering media with deep learning on time resolved measurement,” Opt. Express 25, 17466-17479 (2017).] and video compressed sensing [M. Iliadis, L. Spinoulas, and A. K. Katsaggelos, “Deepbinarymask: Learning a binary mask for video compressive sensing,” CoRR abs/1607.03343 (2016)]. The technique of the present embodiments differs from all these contributions as it presents a more general design approach, applied for DOF extension, with a possible extension to blind image deblurring and low-light imaging. In addition, this Example shows that the improvement achieved by the mask design is not specific to post processing performed by a neural network; it can also be utilized with other restoration method, such as sparse coding.

The method of the present embodiments is based on manipulating the PSF/MTF of the imaging system based on a desired joint color and depth variance. Generally, one may design a simple binary phase-mask to generate a MTF with color diversity such that at each depth in the desired DOF, at least one color channel provides a sharp image [B. Milgrom, N. Konforti, M. A. Golub, and E. Marom, “Novel approach for extending the depth of field of barcode decoders by using rgb channels of information,” Opt. express 18, 17027-17039 (2010)]. This design can be used as-is (without a post-processing step) for simple computer vision application such as barcode reading, and also for all-in-focus image recovery using a dedicated post-processing step.

The basic principle behind the mask operation, is that a single-ring phase-mask exhibiting a π-phase shift for a certain illumination wavelength allows very good DOF extension capabilities. A property of the phase mask of the present embodiments (and therefore of the imaging system), is that it manipulates the PSF of the system as a function of the defocus condition. In other words, the method of the present embodiments is not designed to handle a specific DOF (in meters), but to a certain defocus domain in the vicinity of the original focus point (ψ=0). Thus, a reconstruction algorithm based on such phase-mask depends on the defocus range rather than on the actual depth of the scene. The defocus domain is quantified using the ψ defocus measure, defined as:

$$ψ = \frac{π {R}^{2}}{λ} ( \frac{1}{{z}_{o}} + \frac{1}{{z}_{img}} - \frac{1}{f} ) = \frac{π {R}^{2}}{λ} ( \frac{1}{{z}_{i m g}} - \frac{1}{{z}_{i}} ) = \frac{π {R}^{2}}{λ} ( \frac{1}{{z}_{o}} - \frac{1}{{z}_{n}} ) \qquad ( EQ . 1.1 )$$

where z_{img} is the sensor plane location for an object in the nominal position (zₙ); zᵢ is the ideal image plane for an object located at zₒ; f and R are the imaging system focal length and exit pupil radius; and λ is the illumination wavelength. The phase shift φ applied by a phase ring is expressed as:

$$φ = \frac{2 π}{λ} ( n - 1 ) h \qquad ( EQ . 1.2 )$$

where λ is the illumination wavelength, n is the refractive index, and h is the ring height. Notice that the performance of such a mask is sensitive to the illumination wavelength. Taking advantage of the nature of the diffractive optical element structure, such a mask can be designed for a significantly different response for each band in the illumination spectrum. For the common color RGB sensor, three ‘separate’ system behaviors can be generated with a single mask, such that in each depth of the scene, a different channel is in focus while the others are not.

An end-to-end deep learning process based on large datasets, which is devoid of previous designer intuitions, can lead to improved performance. In view of this notion, the phase-mask is optionally and preferably designed together with the CNN model using backpropagation. In order to make such a design, the optical imaging operation is optionally and preferably modeled as the first layer of the CNN. In this case, the weights of the optical imaging layer are the phase-mask parameters: the phase ring/s radii rᵢ, and the phase shifts φᵢ. Thus, the imaging operation is modeled as the ‘forward step’ of the optical imaging layer.

To design the phase mask pattern in conjunction with the CNN using backpropagation, computation of the relevant derivatives (∂PSF/∂rᵢ, ∂PSF/∂φᵢ) can be carried out when the ‘backward pass’ is carried. Using backpropagation theory, the optical imaging layer is integrated in a DL model, and its weights (for example, the phase mask parameters) are optionally and preferably learned together with the classic CNN model so that optimal end-to-end performance is achieved (detailed description of the forward and backward steps of the optical imaging layer is provided in Example 3).

As mentioned above, the optical imaging layer is ψ-dependent and not distance dependent. The ψ dependency enables an arbitrary setting of the focus point, which in turns ‘spreads’ the defocus domain under consideration for a certain depth, as determined by EQ. (1). This is advantageous since the CNN is trained in the ψ domain, and thereafter one can translate it to various scenes where actual distances appear. The range of ψ values on which the network is optimized is a hyper-parameter of the optical imaging layer. Its size tradeoffs the depth range for which the network performs the all-in-focus operation vs. the reconstruction accuracy.

In the present analysis, the domain was set to ψ=[0, 8], as it provides a good balance between the reconstruction accuracy and depth of field size. For such setting, a circularly symmetric phase-ring/s pattern, having up to three rings was examined. Such phase mask patterns are trained along with the all in-focus CNN (described below). It was found that a single phase-ring mask was sufficient to provide most of the required PSF coding, and the added-value of additional phase rings is negligible. Thus, in the performance vs. fabrication complexity tradeoff, a single-ring mask was selected.

The optimized parameters of the mask are r=[0.68, 1] and φ=2.89π (both ψ and φ are defined for the blue wavelength, where the RGB wavelengths taken are the peak wavelengths of the camera color filter response: λ_{R,G,B}=[600, 535, 455] nm). Since the solved optimization problem is non-convex, a global/local minima analysis is required. Various initial guesses for the mask parameters were experimented. For the domain of 0.6<r₁<0.8, 0.8<r₂<1 and 2π<ψ<4π the process converged to the same values mentioned above. However, for initial values outside this domain, the convergence was not always to the same minimum (which is probably the global one). Therefore, the process has some sensitivity to the initial values (as almost any non-convex optimization), but this sensitivity is relatively low. It can be mitigated by trying several initialization points and then picking the one with the best minimum value.

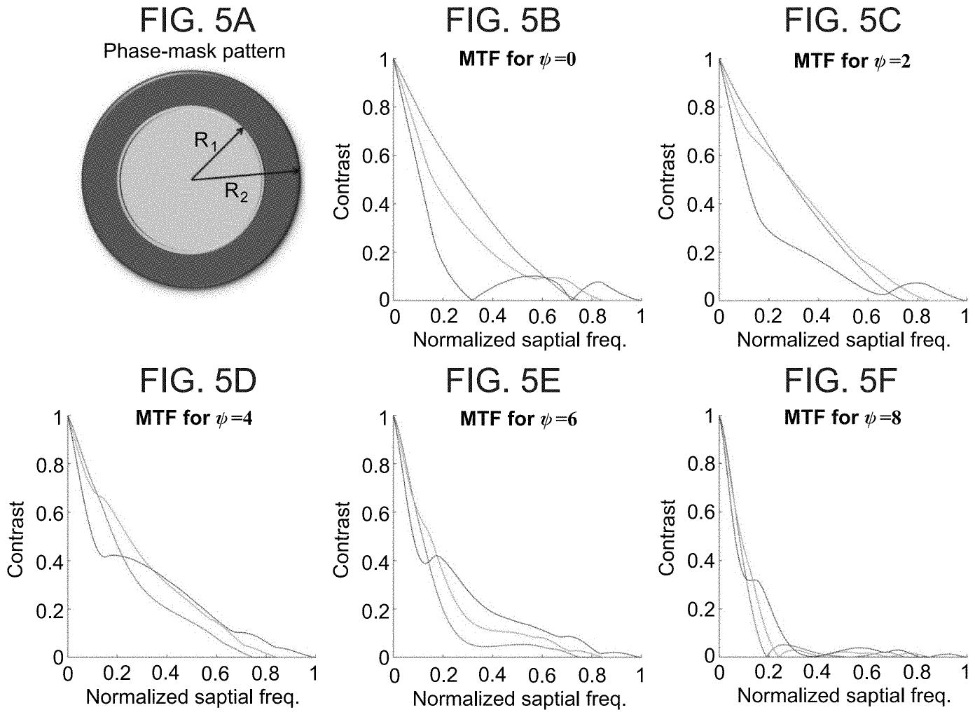

FIGS. 5A-F present the MTF curves of the system with the optimized phase mask incorporated for various defocus conditions. The separation of the RGB channels is clearly visible. This separation serves as a prior for the all in-focus CNN described below.

The first layer of the CNN model of the present embodiments is the optical imaging layer. It simulates the imaging operation of a lens with the color diversity phase-mask incorporated. Thereafter, the imaging output is fed to a conventional CNN model that restores the all-in-focus image. In this Example, the DL jointly designs the phase-mask and the network restores the all-in-focus image.

The EDOF scheme of the present embodiments can be considered as a partially blind deblurring problem (partially, since only blur kernels inside the required EDOF are considered in this Example). Typically, a deblurring problem is an ill-posed problem. Yet, in this case the phase mask operation makes this inverse problem more well-posed by manipulating the response between the different RGB channels, which makes the blur kernels coded in a known manner.

Due to that fact, a relatively small CNN model can approximate this inversion function. One may consider that in some sense the optical imaging step (carried with a phase mask incorporated in the pupil plane of the imaging system) performs part of the required CNN operation, with no conventional processing power needed. Moreover, the optical imaging layer ‘has access’ to the object distance (or defocus condition), and as such it can use it for smart encoding of the image. A conventional CNN (operating on the resultant image) cannot perform such encoding. Therefore the phase coded aperture imaging leads to an overall better deblurring performance of the network.

The model was trained to restore all-in-focus natural scenes that have been blurred with the color diversity phase-mask PSFs. This task is generally considered as a local task (image-wise), and therefore the training patches size was set to 64×64 pixels. Following the locality assumption, if natural images are inspected in local neighborhoods, (e.g., focus on small patches in them), almost all of these patches seem like a part of a generic collection of various textures.

Thus, in this Example the CNN model is trained with the Describable Textures Dataset (DTD) [34], which is a large dataset of various natural textures. 20K texture patches of size 64×64 pixels were taken. Each patch is replicated a few times such that each replication corresponds to a different depth in the DOF under consideration. In addition, data augmentation by rotations of 90°, 180° and 270° was used, to achieve rotation-invariance in the CNN operation. 80% of the data is used for training, and the rest for validation.

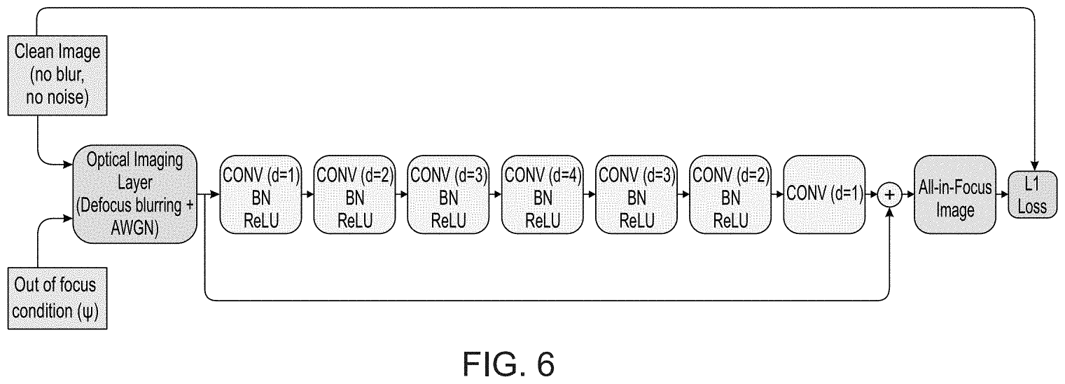

FIG. 6 presents the all-in-focus CNN model. It is based on consecutive layers composed of a convolution (CONV), Batch Normalization (BN) and the Rectified Linear Unit (ReLU). Each CONV layer contains 32 channels with 3×3 kernel size. In view of the model presented in [19], the convolution dilation parameter (denoted by d in FIG. 3) is increased and then decreased, for receptive field enhancement. Since the target of the network is to restore the all-in-focus image, it is much easier for the CNN model to estimate the required ‘correction’ to the blurred image instead of the corrected image itself. Therefore, a skip connection is added from the imaging result directly to the output, in such a way that the consecutive convolutions estimate only the residual image. Note that the model does not contain any pooling layers and the CONV layers stride is always one, meaning that the CNN output size is equal to the input size.

The restoration error was evaluated using the L1 loss function. The L1 loss serves as a good error measure for image restoration, since it does not over penalize large error (like the L2 loss), which results in a better image restoration for a human observer. The network was trained using SGD+momentum solver (with γ=0.9), with batch size of 100, weight decay of 5e-4 and learning rate of 1e-4 for 2500 epochs. Both training and validation loss functions converged to L₁≈6.9 (on a [0, 255] image intensity scale), giving evidence to a good reconstruction accuracy and a negligible over-fitting.

Since the mask fabrication process has its inherent errors, sensitivity analysis is preferred. By fixing the CNN computational layers and perturbing the phase-mask parameters, it can be deduced that fabrication errors of 5% (either in r or φ) results in performance degradation of 0.5%, which is tolerable. Moreover, to compensate these errors one may fine-tune the CNN computational layers with respect to the fabricated phase-mask, and then most of the lost quality is gained back.

Due to the locality assumption and the training dataset generation process, the trained CNN both (i) encapsulates the inversion operation of all the PSFs in the required DOF; and (ii) performs a relatively local operation. Thus, a real-world image comprising an extensive depth can be processed ‘blindly’ with the restoration model; each different depth (for example, defocus kernel) in the image is optionally and preferably restored appropriately, with no additional guidance on the scene structure.

### Simulation Results

To demonstrate the advantage of the end-to-end training of the mask and the reconstruction CNN, it was first tested using simulated imaging. As an input, an image from a ‘TAU-Agent’ dataset was created. The Agent dataset includes synthetic realistic scenes created using ‘Blender’ computer graphics software. Each scene consists of an all-in focus image with low-noise level, along with its corresponding pixel-wise accurate depth map. Such data enables an exact depth dependent imaging simulation, with the corresponding DOF effects.

For demonstration, a close-up photo image of a man's face, with a wall in the background (see FIG. 7A) was taken. Such a scene serves as a ‘stress-test’ for an EDOF camera, since focus on both the face and the wall cannot be maintained. For performance comparison, a smart-phone camera with a lens similar to the one presented in [36] (f=4.5 mm, F #=2.5), and a sensor with pixel size of 1.2 μm, were taken. The imaging process of a system with the learned phase coded aperture was simulated on this image, and then the corresponding CNN was used to process it.

The simulation results are shown in FIGS. 7A-J. Shown is an all-in-focus example of a simulated scene with intermediate images. Accuracy is presented in PSNR [db]/SSIM. FIG. 7A shows the original all-in focus-scene. Its reconstruction (using imaging simulation with the proper mask followed by a post-processing stage) is shown in FIGS. 7B-J: FIG. 7B shows reconstruction by Dowski and Cathey method—imaging with phase mask result; FIG. 7C shows reconstruction by the original processing result of Dowski and Cathey method—Wiener filtering; FIG. 7D shows reconstruction by Dowski and Cathey mask image with the deblurring algorithm of K. Zhang, W. Zuo, S. Gu, and L. Zhang supra; FIG. 7E shows the initial mask used in the present embodiments (without training) imaging result; FIG. 7F shows reconstruction by deblurring of FIG. 7E using the method of Haim, Bronstein and Marom supra; FIG. 7F shows reconstruction by deblurring of FIG. 7G using the CNN of the present embodiments, trained for the initial mask; FIG. 7H shows reconstruction by the trained (along with CNN) mask imaging result; FIG. 7I shows reconstruction by deblurring of FIG. 7H using the method of Haim, Bronstein and Marom supra; FIG. 7J shows reconstruction by trained mask imaging and corresponding CNN of the present embodiments.

For comparison, the same process was performed using the EDOF method of Dowski and Cathey (with the mask parameter α=40). Two variants of the Dowski and Cathey method are presented: with the original processing (simple Wiener filtering), and using one of the state-of-the-art non-blind image deblurring methods (Zhang et al.).

In both cases, a very moderate noise is added to the imaging result, simulating a high quality sensor noise in very good lighting conditions (AWGN with σ=3).

As shown in FIGS. 7A-J, the method of Dowski and Cathey is very sensitive to noise (in both processing methods), due to the narrow bandwidth MTF of the imaging system and the noise amplification of the post-processing stage. Ringing artifacts are also very dominant. In the method of the present embodiments, where in each depth a different color channel provides good resolution, the deblurring operation is considerably more robust to noise and provides much better results.

In order to estimate the contribution of the phase mask parameters training compared to a mask designed separately, a similar simulation was performed with the mask presented by Haim, Bronstein and Marom supra and a CNN model fine tuned for it (similar model to the present embodiments but without training the mask parameters). The results are presented in FIGS. 7G and 7J. While using a separately designed mask based on optical considerations leads to good performance, a joint training of the phase-mask along with the CNN results in an improved overall performance. In addition, the phase-mask trained along with the CNN achieves improved performance even when using the sparse coding based processing presented in Haim, Bronstein and Marom (see FIGS. 7F and 7I). Therefore, the design of optics related parameters using CNN and backpropagation is effective also when other processing methods are used.

### Experimental Results

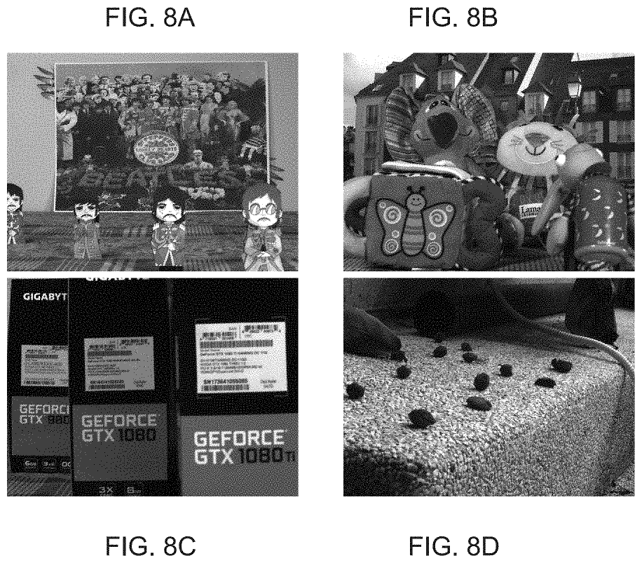

Experimental results are shown in FIGS. 8A-D.

The phase-mask described above was fabricated and an aperture stop of a f=16 mm lens was incorporated it (see FIG. 4). It was then mounted on a 18MP sensor with pixel size of 1.25 μm. This phase coded aperture camera performs the learned optical imaging layer, and then the all-in-focus image can be restored using the trained CNN model. The lens equipped with the phase mask performs the phase-mask based imaging, simulated by the optical imaging layer described above.

This Example presents the all-in-focus camera performance for three indoor scenes and one outdoor scene. In the indoor scenes, the focus point is set to 1.5 m, and therefore the EDOF domain covers the range between 0.5-1.5 m. Several scenes were composed with such depth, each one containing several objects laid on a table, with a printed photo in the background (see FIGS. 8A, 8B and 8C). In the outdoor scene (FIG. 8C), the focus point was set to 2.2 m, spreading the EDOF to 0.7-2.2 m. Since the model is trained on a defocus domain and not on a metric DOF, the same CNN was used for both scenarios.

The performance was compared to two other methods: Krishnan et al. blind deblurring method [D. Krishnan, T. Tay, and R. Fergus, “Blind deconvolution using a normalized sparsity measure,” in “CVPR 2011,” (2011), pp. 233-240] (on the clear aperture image), and the phase coded aperture method of Haim, Bronstein and Marom supra, implemented using the learned phase mask of the present embodiments.

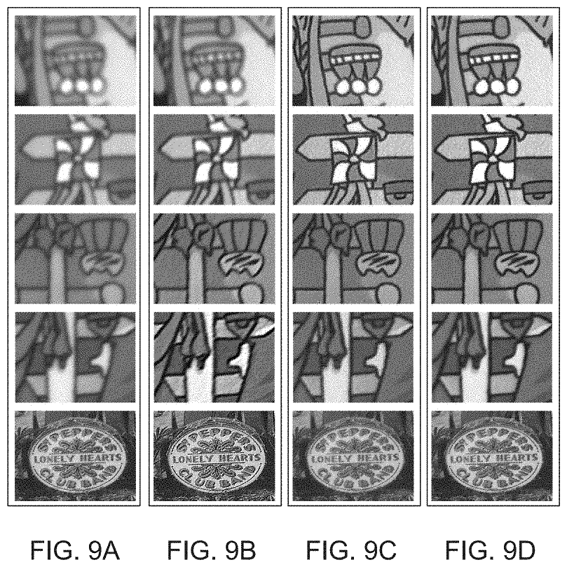

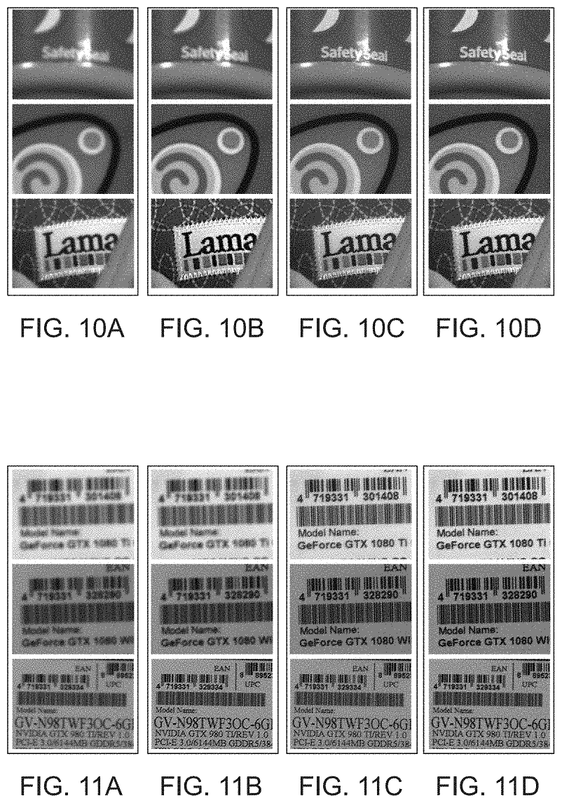

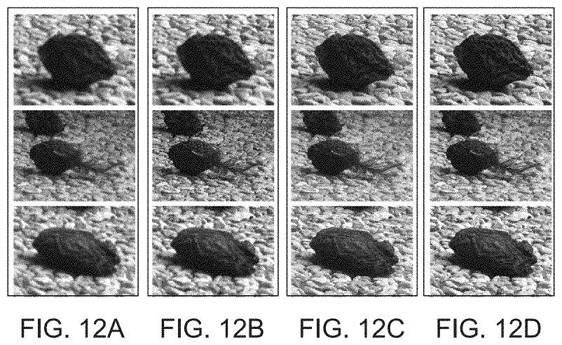

FIGS. 9A-D show examples with different depth from FIG. 8A, FIGS. 10A-D show examples with different depth from FIG. 8B, FIGS. 11A-D show examples with different depth from FIG. 8C, and FIGS. 12A-D show examples with different depth from FIG. 8D. FIGS. 9A, 10A, 11A and 12A: a clear aperture imaging FIGS. 9B, 10B, 11B and 12B: blind deblurring of FIGS. 9A, 10A, 11A and 12A using Krishnan's algorithm; FIGS. 9C, 10C, 11C and 12C: the mask with processing according to Haim, Bronstein and Marom supra; and FIGS. 9D, 10D, 11D and 12D: the method of the present embodiments.

As demonstrated the performance of the technique of the present embodiments is better than Krishnan et al., and better than Haim et al. Note that the optimized mask was use with the method of Haim et al., which leads to improved performance compared to the manually designed mask. Besides the reconstruction performance, the method of the present embodiments outperforms both methods also in runtime by 1-2 orders of magnitude as detailed in Table 1.

TABLE 1
Runtime comparison for a 1024 × 512 image

| Method | CPU [s] | GPU [s] |
|---|---|---|
| Krishnan et al. [37] | 122 | — |
| Zhang et al. [19] | 183 | 3.6 |
| Haim et al. [12] | 19.3 | — |
| The inventive technique | 2.7 | 0.3 |

For the comparison all timings were done on the same machine: Intel i7-2620 CPU and NVIDIA GTX 1080Ti GPU. All the algorithms have been implemented in MATLAB: Krishnan et al. using the code published by the authors; Haim, Bronstein and Marom using the SPAMS toolbox; and Zhang et al. and the technique of the present embodiments using MatConvNet. This is achieved due to the fact that using a learned phase-mask in the optical train enables reconstruction with a relatively small CNN model.

An approach for Depth Of Field extension using joint processing by a phase coded aperture in the image acquisition, followed by a corresponding CNN model was presented. The phase-mask is designed to encode the imaging system response in a way that the PSF is both depth and color dependent. Such encoding enables an all-in-focus image restoration using a relatively simple and computationally efficient CNN.

In order to achieve a better optimum, the phase mask and the CNN are optimized together and not separately as is the common practice. In view of the end-to-end learning approach of DL, the optical imaging was modeled as a layer in the CNN model, and its parameters are ‘trained’ along with the CNN model. This joint design achieves two goals: (i) it leads to a true synergy between the optics and the post-processing step, for optimal performance; and (ii) it frees the designer from formulating the optical optimization criterion in the phase-mask design step.

Improved performance compared to other competing methods, in both reconstruction accuracy as well as run-time is achieved. An important advantage of the method of the present embodiments is that the phase-mask can be easily added to an existing lens, and therefore the technique of the present embodiments for EDOF can be used by any optical designer for compensating other parameters. The fast run-time allows fast focusing, and in some cases may even spare the need for a mechanical focusing mechanism. The final all-in-focus image can be used in both computer vision application, where EDOF is needed, and in “artistic photography” applications for applying refocusing/Bokeh effects after the image has been taken.

The joint optical and computational processing scheme of the present embodiments can be used for other image processing applications such as blind deblurring and low-light imaging. In blind deblurring, it would be possible to use a similar scheme for “partial blind deblurring” (for example, having a closed set of blur kernels such as in the case of motion blur). In low-light imaging, it is desirable to increase the aperture size as larger apertures give more light. the technique of the present embodiments can overcome the DOF issue and allow more light throughput in such scenarios.

### Example 2

Depth Estimation from a Single Image Using Deep Learned Phase Coded Mask

Several approaches for monocular depth estimation have been proposed. The inventors found that all of which have inherent limitations due to the scarce depth cues that exist in a single image. The inventors also found that these methods are very demanding computationally, which makes them inadequate for systems with limited processing power. In this Example, a phase-coded aperture camera for depth estimation is described. The camera is equipped with an optical phase mask that provides unambiguous depth-related color characteristics for the captured image. These are optionally and preferably used for estimating the scene depth map using a fully-convolutional neural network. The phase-coded aperture structure is learned, optionally and preferably together with the network weights using back-propagation. The strong depth cues (encoded in the image by the phase mask, designed together with the network weights) allow a simpler neural network architecture for faster and more accurate depth estimation. Performance achieved on simulated images as well as on a real optical setup is superior to conventional monocular depth estimation methods (both with respect to the depth accuracy and required processing power), and is competitive with more complex and expensive depth estimation methods such as light field cameras.

A common approach for passive depth estimation is stereo vision, where two calibrated cameras capture the same scene from different views (similarly to the human eyes), and thus the distance to every object can be inferred by triangulation. It was found by the inventors that such a dual camera system significantly increases the form factor, cost and power consumption.

The current electronics miniaturization trend (high quality smart-phone cameras, wearable devices, etc.) requires a much more compact and low-cost solution. This requirement dictates a more challenging task: passive depth estimation from a single image. While a single image lacks the depth cues that exist in a stereo image pair, there are still some depth cues such as perspective lines and vanishing points that enable depth estimation to some degree of accuracy. Some neural network-based approaches to monocular depth estimation exist in the literature [Y. Cao, Z. Wu, and C. Shen, “Estimating depth from monocular images as classification using deep fully convolutional residual networks,” CoRR, vol. abs/1605.02305, 2016. [Online]. Available: arxivDOTorg/abs/1605.02305; D. Eigen, C. Puhrsch, and R. Fergus, “Depth map prediction from a single image using a multi-scale deep network,” in Advances in Neural Information Processing Systems 27, Z. Ghahramani, M. Welling, C. Cortes, N. D. Lawrence, and K. Q. Weinberger, Eds. Curran Associates, Inc., 2014, pp; 2366-2374. [Online]. Available: papersDOTnipsDOTcc/paper/5539-depth-map-prediction-from-a-single-image-using-a-multi-scale-deep-network.pdf; C. Godard, O. Mac Aodha, and G. J. Brostow, “Unsupervised monocular depth estimation with left-right consistency,” CoRR, vol. abs/1609.03677, 2016. [Online]. Available: arxivDOTorg/abs/1609.03677; H. Jung and K. Sohn, “Single image depth estimation with integration of parametric learning and non-parametric sampling,” Journal of Korea Multimedia Society, vol. 9, no. 9, September 2016. [Online]. Available: dxDOTdoiDOTorg/10.9717/kmms.2016.19.9.1659; I. Laina, C. Rupprecht, V. Belagiannis, F. Tombari, and N. Navab, “Deeper depth prediction with fully convolutional residual networks,” CoRR, vol. abs/1606.00373, 2016. [Online]. Available: arxivDOTorg/abs/1606.00373; F. Liu, C. Shen, G. Lin, and I. Reid, “Learning depth from single monocular images using deep convolutional neural fields,” IEEE Transactions on Pattern Analysis and Machine Intelligence].

Common to all these approaches is the use of depth cues in the RGB image ‘as-is’, as well as having the training and testing on well-known public datasets such as the NYU depth, and Make3D. Since the availability of reliable depth cues in a regular RGB image is limited, these approaches require large architectures with significant regularization (Multiscale, ResNets, CRF) as well as separation of the models to indoor/outdoor scenes. A modification of the image acquisition process itself seems necessary in order to allow using a simpler model generic enough to encompass both indoor and outdoor scenes. Imaging methods that use an aperture coding mask (both phase or amplitude) became more common in the last two decades. However, the inventor found that in all these methods the captured and restored images have a similar response in the entire DOF, and thus depth information can only be recovered using monocular cues.

To take advantage of optical cues as well, the PSF can be depth-dependent. Related methods use an amplitude coded mask, or a color-dependent ring mask such that objects at different depths exhibit a distinctive spatial structure. The inventors found that a drawback of these strategies is that the actual light efficiency is only 50%-80%, making them unsuitable for low light conditions. Moreover, some of those techniques are unsuitable for small-scale cameras since they are less sensitive to small changes in focus.

This Example describes a novel deep learning framework for the joint design of a phase-coded aperture element and a corresponding FCN model for single-image depth estimation. A similar phase mask has been proposed by Milgrom [B. Milgrom, N. Konforti, M. A. Golub, and E. Marom, “Novel approach for extending the depth of field of barcode decoders by using rgb channels of information,” Optics express, vol. 18, no. 16, pp. 17027-17039, 2010] for extended DOF imaging; its major advantage is light efficiency above 95%. The phase mask of the present embodiments is designed to increase sensitivity to small focus changes, thus providing an accurate depth measurement for small-scale cameras (such as smartphone cameras).

In the system of the present embodiments, the aperture coding mask is designed for encoding strong depth cues with negligible light throughput loss. The coded image is fed to a FCN, designed to observe the color-coded depth cues in the image, and thus estimate the depth map. The phase mask structure is trained together with the FCN weights, allowing end-to-end system optimization. For training, the ‘TAU-Agent’ dataset was created, with pairs of high-resolution realistic animation images and their perfectly registered pixel-wise depth maps.

Since the depth cues in the coded image are much stronger than their counterparts in a clear aperture image, the FCN of the present embodiments is much simpler and smaller compared to other monocular depth estimation networks. The joint design and processing of the phase mask and the proposed FCN lead to an improved overall performance: better accuracy and faster run-time compared to the known monocular depth estimation methods are attained. Also, the achieved performance is competitive with more complex, cumbersome and higher cost depth estimation solutions such as light field cameras.

The need to acquire high-quality images and videos of moving objects in low-light conditions establish the well-known trade-off between the aperture size (F #) and the DOF in optical imaging systems. With conventional optics, increasing the light efficiency at the expense of reduced DOF poses inherent limitations on any purely computational technique, since the out-of-focus blur may result in information loss in parts of the image.

This adopts a phase mask for depth reconstruction. This Example shows that this mask introduces depth-dependent color cues throughout the scene, which lead to a fast and accurate depth estimation. Due to the optical cues based depth estimation, the generalization ability of the method of the present embodiments is better compared to the current monocular depth estimation methods.

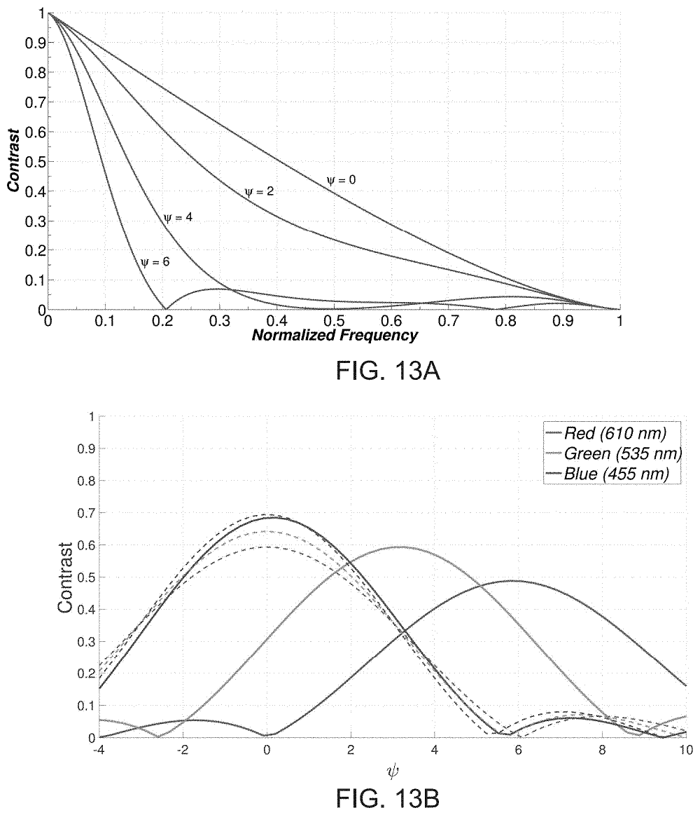

An imaging system acquiring an out-of-focus (OOF) object can be described analytically using a quadratic phase error in its pupil plane. In the case of a circular aperture with radius R, the defocus parameter is defined as

$$\begin{matrix}ψ = \frac{π {R}^{2}}{λ} ( \frac{1}{{z}_{o}} + \frac{1}{{z}_{img}} - \frac{1}{f} ) = \frac{π {R}^{2}}{λ} ( \frac{1}{{z}_{img}} - \frac{1}{{z}_{i}} ) \\ = \frac{π {R}^{2}}{λ} ( \frac{1}{{z}_{o}} - \frac{1}{{z}_{n}} ) ,\end{matrix} \qquad ( EQ . 2.1 )$$

where z_{img} is the sensor plane location of an object in the nominal position (zₙ), zᵢ is the ideal image plane for an object located at zₒ, and λ is the optical wavelength. Out-of-focus blur increases with the increase of |ψ|; the image exhibits gradually decreasing contrast level that eventually leads to information loss (see FIG. 13A).

Phase masks with a single radially symmetric ring can introduce diversity between the responses of the three major color channels (R, G and B) for different focus scenarios, such that the three channels jointly provide an extended DOF. In order to allow more flexibility in the system design, a mask with two or three rings is used, whereby each ring exhibits a different wavelength-dependent phase shift. In order to determine the optimal phase mask parameters within a deep learning-based depth estimation framework, the imaging stage is modeled as the initial layer of a CNN model. The inputs to this coded aperture convolution layer are the all-in-focus images and their corresponding depth maps. The parameters (or weights) of the layer are the radii rᵢ and phase shifts φᵢ of the mask's rings.

Such layer forward model is composed of the coded aperture PSF calculation (for each depth in the relevant depth range) followed by imaging simulation using the all-in-focus input image and its corresponding depth map. The backward model uses the inputs from the next layer (backpropagated to the coded aperture convolutional layer) and the derivatives of the coded aperture PSF with respect to its weights, ∂PSF/∂rᵢ, ∂PSF/∂φᵢ, in order to calculate the gradient descent step on the phase mask parameters. A detailed description of the coded aperture convolution layer and its forward and backward models is presented in Example 3. One of the hyper-parameters of such a layer is the depth range under consideration (in ψ terms). The ψ range setting, together with the lens parameters (focal length, F # and focus point) dictates the trade-off between the depth dynamic range and resolution. In this Example, this range is set to ψ=[−4,10]; its conversion to the metric depth range is presented below. The optimization of the phase mask parameters is done by integrating the coded aperture convolutional layer into the CNN model detailed in the sequel, followed by the end-to-end optimization of the entire model. To validate the coded aperture layer, the case where the CNN (described below) is trained end-to-end with the phase coded aperture layer was compared to the case where the phase mask is held fixed to its initial value. Several fixed patterns were examined, and the training of the phase mask improves the classification error by 5% to 10%.

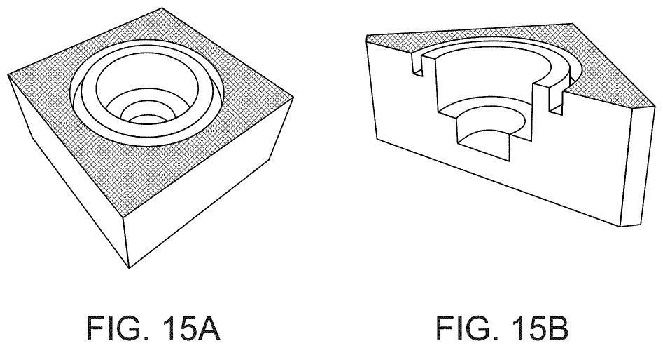

The optimization process yields a three rings mask such that the outer ring is deeper than the middle one as illustrated in FIGS. 15A and 15B. Since an optimized three-rings mask surpass the two-ring mask only by a small margin, in order to make the fabrication process simpler and more reliable, a two-ring limit was set in the training process; this resulted in the normalized ring radii r={0.55,0.8,0.8,1} and phases φ={6.2,12.3} [rad]. FIG. 13B shows the diversity between the color channels for different depths (expressed in ψ values) when using a clear aperture (dotted plot) and the optimized phase mask (solid plot).

Following is a description of the architecture of our fully convolutional network (FCN) for depth estimation, which relies on optical cues encoded in the image, provided by the phase coded aperture incorporated in the lens as described in above. These cues are used by the FCN model to estimate the scene depth. The network configuration is inspired by the FCN structure introduced by Long et al. [J. Long, E. Shelhamer, and T. Darrell, “Fully convolutional networks for semantic segmentation,” CVPR, November 2015]. That work converts an ImageNet classification CNN to a semantic segmentation FCN by adding a deconvolution block to the ImageNet model, and then fine-tunes it for semantic segmentation (with several architecture variants for increased spatial resolution). For depth estimation using the phase coded aperture camera, a totally different ‘inner net’ optionally and preferably replaces the “ImageNet model”. The inner net can classify the different imaging conditions (for example, ψ values), and the deconvolution block can turn the initial pixel labeling into a full depth estimation map. Two different ‘inner’ network architectures were tested: a first based on the DenseNet architecture, and a second based on a traditional feed-forward architecture. An FCN based on both inner nets is presented, and the trade-off is discussed. In the following the ψ classification inner nets, and the FCN model based on them for depth estimation are presented.

The phase coded aperture is designed along with the CNN such that it encodes depth-dependent cues in the image by manipulating the response of the RGB channels for each depth. Using these strong optical cues, the depth slices (i.e. ψ values) can be classified using some CNN classification model.

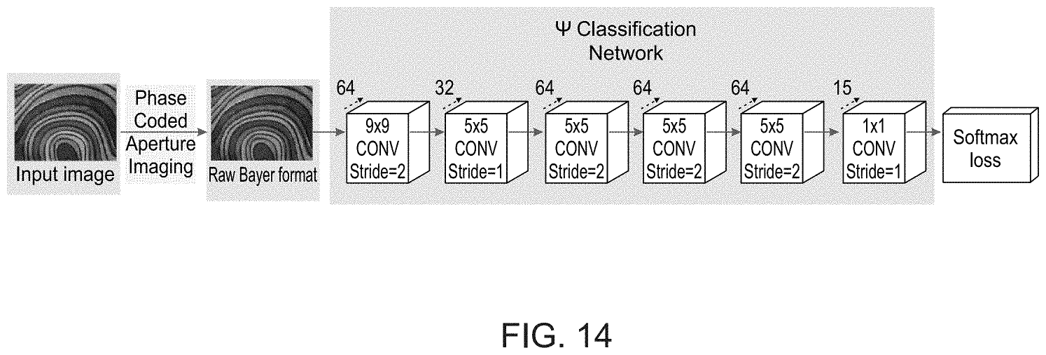

For this task, two different architectures were tested; the first one based on the DenseNet architecture for CIFAR-10, and the second based on the traditional feed-forward architecture of repeated blocks of convolutions, batch normalization and rectified linear units (CONV-BN-ReLU, see FIG. 14). Pooling layers are omitted in the second architecture, and stride of size 2 is used in the CONV layers for lateral dimension reduction. This approach allows much faster model evaluation (only 25% of the calculation in each CONV layer), with minor loss in performance.

To reduce the model size and speed up its evaluation even more, the input (in both architectures) to the first CONV layer of the net is the raw image (in mosaicked Bayer pattern). By setting the stride of the first CONV layer to 2, the filters' response remains shift-invariant (since the Bayer pattern period is 2). This way the input size is decreased by a factor of 3, with minor loss in performance. This also omits the need for the demosaicking stage, allowing faster end-to-end performance (in cases where the RGB image is not needed as an output, and one is interested only in the depth map). One can see the direct processing of mosaicked images as a case where the CNN representation power ‘contains’ the demosaicking operation, and therefore it is not needed as a preprocessing step.

Both inner classification net architectures are trained on the Describable Textures Dataset (DTD). About 40K texture patches (32×32 pixels each) are taken from the dataset. Each patch is ‘replicated’ in the dataset 15 times, where each replication corresponds to a different blur kernel (corresponding to the phase coded aperture for ψ=−4, −3, . . . , 10). The first layer of both architectures represents the phase-coded aperture layer, whose inputs are the clean patch and its corresponding ψ value. After the imaging stage is done, an Additive White Gaussian Noise (AWGN) with σ=3 is added to each patch to make the network more robust to noise, which appear in images taken with a real-world camera. Data augmentation of four rotations is used to increase the dataset size and achieve rotation invariance. The dataset size is about 2.4M patches, where 80% of it is used for training and 20% is used for validation. both nets are trained to classify into 15 integer values of ψ (between −4 and 10) using the softmax loss. These nets are used as an initialization for the depth estimation FCN.

The deep learning based methods for depth estimation from a single image mentioned above rely strongly on the input image details. Thus, most studies in this field assume an input image with a large DOF such that most of the acquired scene is in focus. This assumption is justified when the photos are taken by small aperture cameras as is the case in datasets such as NYU Depth, and Make3D that are commonly used for the training and testing of those depth estimation techniques. However, such optical configurations limit the resolution and increase the noise level, thus, they reduce the image quality. Moreover, the depth maps in those dataset are prone to errors due to depth sensor inaccuracies and calibrations issues (alignment and scaling) with the RGB sensor.

The optical setup of the present embodiments optionally and preferably uses a dataset containing simulated phase coded aperture images and the corresponding depth maps. To simulate the imaging process properly, the input data should contain high resolution, all in-focus images with low noise, accompanied by accurate pixelwise depth maps. This kind of input may be generated almost only using 3D graphic simulation software. Thus, the MPI-Sintel depth images dataset, created by the Blender 3D graphics software was used. The Sintel dataset contain 23 scenes with total of 1 k images. Yet, because it has been designed specifically for optical flow evaluation, the depth variation in each scene does not change significantly. Thus, about 100 unique images were used, which is not enough for training. The need for additional data has led the inventors to create a new Sintel-like dataset (using Blender) called ‘TAU-Agent’, which is based on the new open movie ‘Agent 327’. This new animated dataset, which relies on the new render engine ‘Cycles’, contains 300 realistic images (indoor and outdoor), with resolution of 1024×512, and corresponding pixelwise depth maps. With rotations augmentation, the full dataset contains 840 scenes, where 70% are used for training and the rest for validation.

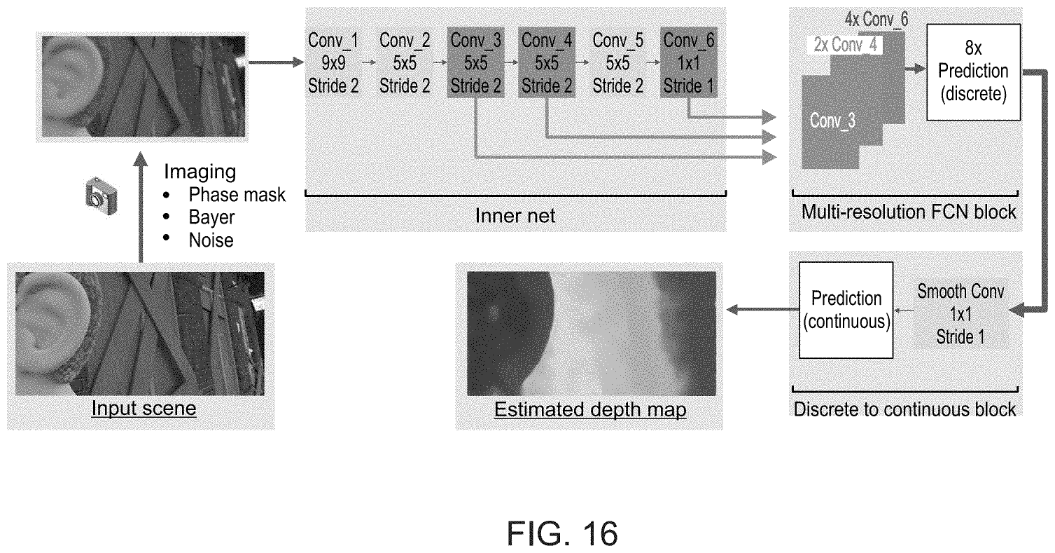

In similarity to the FCN model presented by Long et al. the inner ψ classification net is wrapped in a deconvolution framework, turning it to a FCN model (see FIG. 16). The desired output of the depth estimation FCN of the present embodiments is a continuous depth estimation map. However, since training continuous models is prone to over-fitting and regression to the mean issues, this goal was pursued in two stages. In the first one, the FCN is trained for discrete depth estimation. On the second step, the discrete FCN model is used as an initialization for the continuous model training.

In order to train the discrete depth FCN, the Sintel and Agent datasets RGB images are blurred using the coded aperture imaging model, where each object is blurred using the relevant blur kernel according to its depth (indicated in the ground truth pixelwise depth map). The imaging is done in a quasi-continuous way, with ψ step of 0.1 in the range of ψ=[−4,10]. This imaging simulation can be done in the same way as the ‘inner’ net training, i.e. using the phase coded aperture layer as the first layer of the FCN model. However, such step is very computationally demanding, and do not provide significant improvement (since the phase-coded aperture parameters tuning reached its optimum in the inner net training). Therefore, in the FCN training stage, the optical imaging simulation is done as a pre-processing step with the best phase mask achieved in the inner net training stage. In the discrete training step of the FCN, the ground-truth depth maps are discretized to ψ=−4, −3, . . . , 10 values. The Sintel/Agent images (after imaging simulation with the coded aperture blur kernels, RGB-to-Bayer transformation and AWGN addition), along with the discretized depth maps, are used as the input data for the discrete depth estimation FCN model training. The FCN is trained for reconstructing the discrete depth of the input image using softmax loss.

After training, both versions of the FCN model (based on the DenseNet architecture and the traditional feed-forward architecture) achieved roughly the same performance, but with a significant increase in inference time (×3), training time (×5) and memory requirements (×10) for the DenseNet model. When examining the performance, one can see that most of the errors are on smooth/low texture areas of the images, where the method of the present embodiments (which relies on texture) is expected to be weaker. Yet, in areas with ‘sufficient’ texture, there are also encoded depth cues which enable good depth estimation even with relatively simple DNN architecture. This similarity in performance between the DenseNet based model (which is one of the best CNN architectures known to date) to a simple feed-forward architecture is a clear example to the inherent power of optical image processing using coded aperture—a task driven design of the image acquisition stage can potentially save significant resources in the digital processing stage. Therefore, the simple feed-forward architecture was selected as the chosen solution.

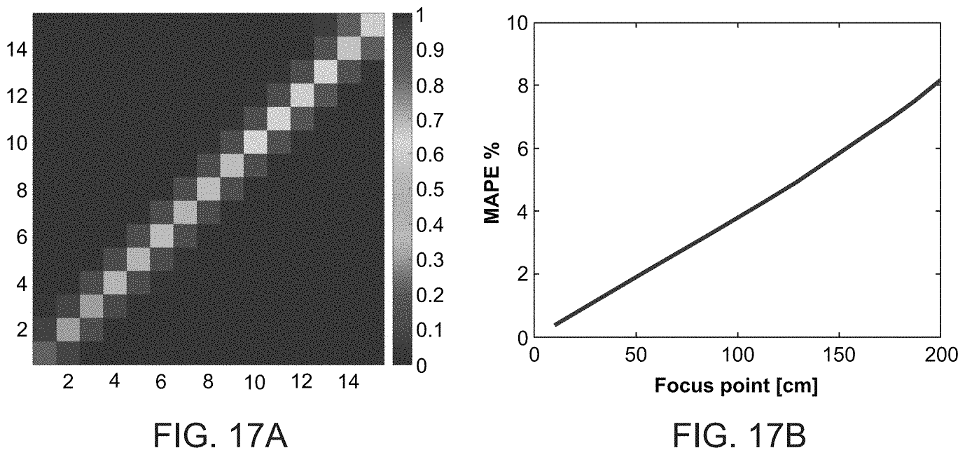

To evaluate the discrete depth estimation accuracy a confusion matrix was calculated for the validation set (˜250 images, see FIG. 17A). After 1500 epochs, the net achieves accuracy of 68% (top-1 error). However, the vast majority of the errors are to adjacent ψ values, and on 93% of the pixels the discrete depth estimation FCN recover the correct depth with an error of up to ±1ψ. As already mentioned above, most of the errors originate from smooth areas, where no texture exists and therefore no depth dependent color-cues were encoded. This performance is sufficient as an initialization point for the continuous depth estimation network.

The discrete depth estimation (segmentation) FCN model is upgraded to a continuous depth estimation (regression) model using some modifications. The linear prediction results serve as an input to a 1×1 1×1 CONV layer, initialized with linear regression coefficients from the ψ predictions to a continuous ψ values (ψ values can be easily translated to depth value in meters, assuming known lens parameters and focus point).

The continuous network is fine-tuned in an end to end fashion, with lower learning rate (by a factor of 100) for the pre-trained discrete network layers. The same Sintel & Agent images are used as an input, but with the quasi-continuous depth maps (without discretization) as ground truth, and L2 or L1 loss. After 200 epochs, the model converges to Mean Absolute Difference (MAD) of 0.6ψ. It was found that most of the errors originate from smooth areas (as detailed hereafter).

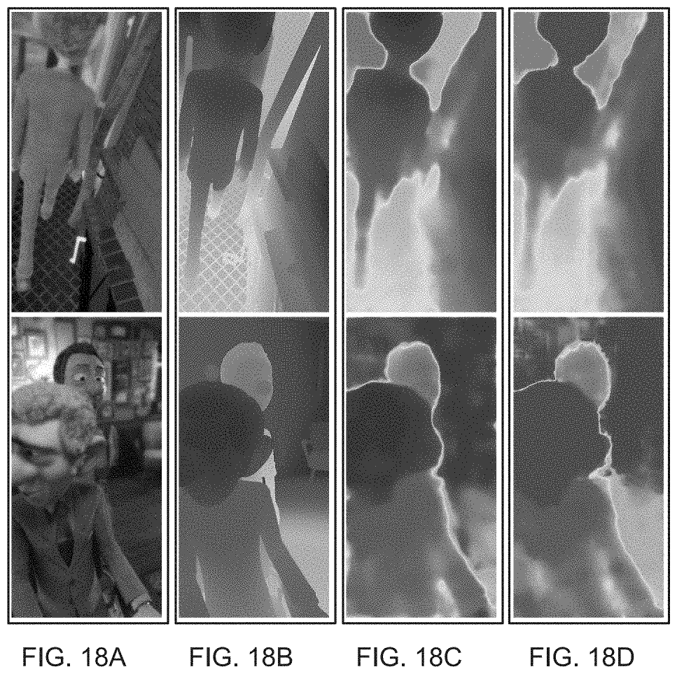

As a basic sanity check, the validation set images can be inspected visually. FIGS. 18A-D show that while the depth cues encoded in the input image are hardly visible to the naked eye, the proposed FCN model achieves quite accurate depth estimation maps compared to the ground truth. Most of the errors are concentrated in smooth areas. The continuous depth estimation smooths the initial discrete depth recovery, achieving a more realistic result.

The method of the present embodiments estimates the blur kernel (ψ value), using the optical cues encoded by the phase coded aperture. An important practical analysis is the translation of the ψ estimation map to a metric depth map. Using the lens parameters and the focus point, transforming from ψ to depth is straight-forward. Using this transformation, the relative depth error can be analyzed. The ψ=[−4,10] domain is spread to some depth dynamic range, depending on the chosen focus point. Close focus point dictates small dynamic range and high depth resolution, and vice versa. However, since the FCN model is designed for ψ estimation, the model (and its ψ⁰ s related MAD) remains the same. After translating to metric maps, the Mean Absolute Percentage Error (MAPE) is different for each focus point. Such analysis is presented in FIG. 17B, where the aperture diameter is set to 2.3 [mm] and the focus point changes from 0.1 [m] to 2 [m], resulting with a working distance of 9[cm] to 30 [m]. One can see that the relative error is roughly linear with the focus point, and remains under 10% for relatively wide focus-point range.

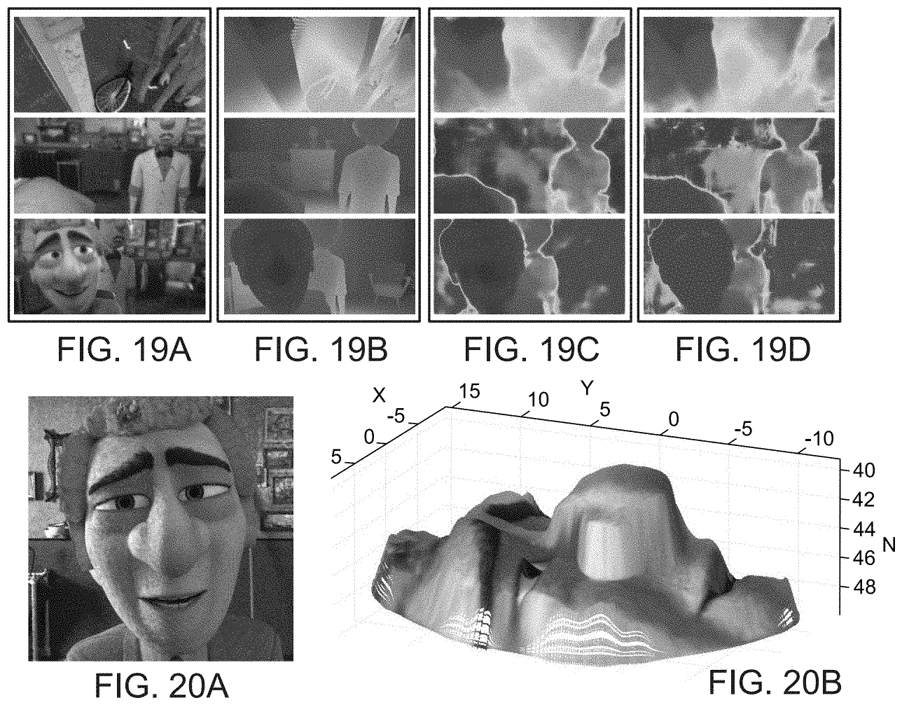

Additional simulated scenes examples are presented in FIGS. 19A-D. The proposed FCN model achieves quite accurate depth estimation maps compared to the ground truth. Notice the difference in the estimated maps when using the L1 loss (FIG. 19C) and the L2 loss (FIG. 19D). The L1 based model produces smoother output but reduces the ability to distinguish between fine details while the L2 model produces noisier output but provide sharper maps. This is illustrated in all scenes when the gap between the body and the hands of the characters is not visible as can be seen in FIG. 19C. Note that in this case the L2 model produces a sharper separation (FIG. 19D). In the top row of FIGS. 19C-D, the fence behind the bike wheel is not visible since the fence wires are too thin. In the middle and bottom rows, the background details are not visible due to low dynamic range in these areas (the background is too far from the camera).

One may increase dynamic range by changing the aperture size/focus point, as will be explained below.

The system is designed to handle ψ range of [−4,10], but the metric range depends on the focus point selection (as presented above). This codependency allows one to use the same FCN model with different optical configurations. To demonstrate this important advantage an image (FIG. 20A) captured with a lens having an aperture of 3.45 [mm] (1.5 the size of the original aperture used for training) was simulated. The larger aperture provides better metrical accuracy in exchange of reducing the dynamic range. The focus point was set to 48[cm], providing a working range of 39[cm] to 53[cm]. Then, an estimated depth map was produced, and was translated into point cloud data using the camera parameters (sensor size and lens focal length) from Blender. The 3D face reconstruction shown in FIG. 20B validates the metrical depth estimation capabilities and demonstrates the efficiency of the technique of the present embodiments, as it was able to create this 3D model in real time.

### Experimental Results

To test the depth estimation method of the present embodiments, several experiments were carried. The experimental setup included an f=16 mm,F/7 lens (LM16JCM-V by Kowa) with the phase coded aperture incorporated in the aperture stop plane (see FIG. 21A). The lens was mounted on a UI3590LE camera made by IDS Imaging. The lens was focused to zₒ=1100 mm, so that the ψ=[−4,10] domain was spread between 0.5-2.2 m. Several scenes were captured using the phase coded aperture camera, and the corresponding depth maps were calculated using the proposed FCN model.

For comparison, two competing solutions were examined on the same scenes: Ilium light field camera (by Lytro), and the monocular depth estimation net proposed by Liu et al. [F. Liu, C. Shen, G. Lin, and I. Reid, “Learning depth from single monocular images using deep convolutional neural fields,” IEEE Transactions on Pattern Analysis and Machine Intelligence, 2016. [Online]. Available: dxDOTdoiDOTorg/10.1109/TPAMI.2015.2505283 [7] J. Long, E. Shelhamer, and T. Darrell, “Fully convolutional networks for semantic segmentation,” CVPR, November 2015]. Since the method in Liu et al. assumes an all in-focus image as an input, the Lytro camera was used all in-focus imaging option as the input for this estimation.

The method of the present embodiments provides depth maps in absolute values (meters), while the Lytro camera and Liu et al. provide a relative depth map only (far/near values with respect to the scene). Another advantage of the technique of the present embodiments is that it requires the incorporation of a very simple optical element to an existing lens, while light-field and other solutions like stereo require a much more complicated optical setup. In the stereo camera, two calibrated cameras are mounted on a rigid base with some distance between them. In the light field camera, special light field optics and detector are used. In both cases the complicated optical setup dictates large volume and high cost.

The inventors examined all the solutions on both indoor and outdoor scenes. Several examples are presented, with similar and different focus points. Indoor scenes examples are shown in FIGS. 22A-D. Several objects were laid on a table with a poster in the background (see FIG. 21B for a side view of the scene). Since the scenes lack global depth cues, the method from Liu et al. fails to estimate a correct depth map. The Lytro camera estimates the gradual depth structure of the scene with good identification of the objects, but provides a relative scale only. The method of the present embodiments succeeds to identify both the gradual depth of the table and the fine details of the objects (top row—note the screw located above the truck on the right, middle row—note the various groups of screws). Although some scene texture ‘seeps’ to the recovered depth map, it causes only a minor error in the depth estimation. A partial failure case appears in the leaflet scene (FIG. 22A-D, bottom row), where the method of the present embodiments misses only on texture-less areas. Performance on non-textured areas is the most challenging scenario to the method of the present embodiments (since it is based on color-coded cues on textures), and it is the source for almost all failure cases. In most cases, the net ‘learns’ to associate non-textured areas with their correct depth using adjacent locations in the scene that have texture and are at similar depth. However, this is not always the case (shown in FIG. 22D, bottom), where it fails to do so in the blank white areas. This issue can be resolved using a deeper network, and it imposes a performance vs. model complexity trade-off.

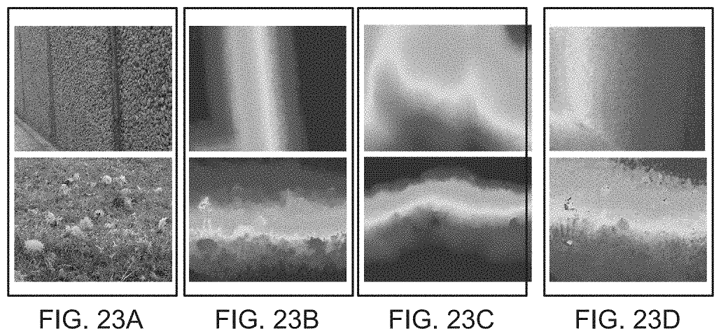

Similar comparison is presented for two outdoor scenes in FIGS. 23A-D. On its first row, a scene consisting of a granulated wall was chosen. In this example, the global depth cues are also weak, and therefore the monocular depth estimation fails to separate the close vicinity of the wall (right part of the image). Both the Lytro and the phase coded aperture camera of the present embodiments achieve good depth estimation of the scene. Note though that the camera of the present embodiments has the advantage that it provides an absolute scale and uses much simpler optics.

On the second row of FIGS. 23A-D, a grassy slope with flowers was chosen. In this case, the global depth cues are stronger. Thus, the monocular method Liu et al. does better compared to the previous examples, but still achieves only a partial depth estimate. Lytro and the camera of the present embodiments achieve good results.

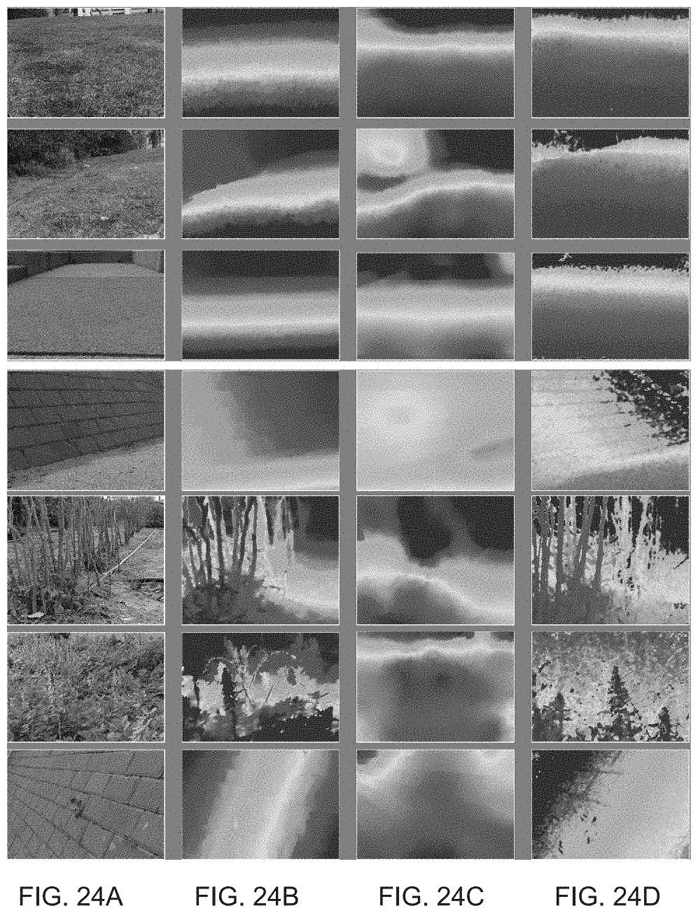

Additional outdoor examples are presented in FIGS. 24A-D. Note that the scenes in first five rows of FIGS. 24A-D were taken with a different focus point (compared to the indoor and the rest of the outdoor scenes), and therefore the depth dynamic range and resolution are different (as can be seen in the depth scale on the right column). However, since the FCN model of the present embodiments is trained for ψ estimation, all depth maps were achieved using the same network, and the absolute depth is calculated using the known focus point and the estimated ψ map.

Besides the depth map recovery performance and the simpler hardware, another important benefit of the technique of the present embodiments is the required processing power/run time. The fact that depth cues are encoded by the phase mask enables much simpler FCN architecture, and therefore much faster inference time. This is due to the fact that some of the processing is done by the optics (in the speed of light, with no processing resources needed). For example, for a full-HD image as an input, the network of the present embodiments evaluates a full-HD depth map in 0.22 s (using Nvidia Titan X Pascal GPU). For the same sized input on the same GPU, the net presented in Liu et al. evaluates a 3-times smaller depth map in 10 s (Timing was measured using the same machine and the implementation of the network in Liu et al. that is available at the authors' website). If a one-to-one input image to depth map is not needed, the output size can be reduced and the FCN can run even faster.

Another advantage of the method of the present embodiments is that the depth estimation relies mostly on local cues in the image. This allows performing of the computations in a distributed manner. The image can be simply split and the depth map can be evaluated in parallel on different resources. The partial outputs can be recombined later with barely visible block artifacts.

This Example presented a method for real-time depth estimation from a single image using a phase coded aperture camera. The phase mask is designed together with the FCN model using back propagation, which allows capturing images with high light efficiency and color-coded depth cues, such that each color channel responds differently to OOF scenarios. Taking advantage of this coded information, a simple convolutional neural network architecture is proposed to recover the depth map of the captured scene.

This proposed scheme outperforms conventional monocular depth estimation methods by having better accuracy, more than an order of magnitude speed acceleration, less memory requirements and hardware parallelization compliance. In addition, the simple and low-cost technique of the present embodiments shows comparable performance to expensive commercial solutions with complex optics such as the Lytro camera. Moreover, as opposed to the relative depth maps produced by those monocular methods and the Lytro camera, the system of the present embodiments provides an absolute (metric) depth estimation, which can be useful to many computer vision applications, such as 3D modeling and augmented reality.

### Example 3

The image processing method of the present embodiments (e.g., depth estimation, all-in focus imaging, motion blur correction, etc.) is optionally and preferably based on a phase-coded aperture lens that introduces cues in the resultant image. The cues are later processed by a CNN in order to produce the desired result. Since the processing is done using deep learning, and in order to have an end-to-end deep learning based solution, the phase-coded aperture imaging is optionally and preferably modeled as a layer in the deep network and its parameters are optimized using backpropagation, along with the network weights. This Example presents in detail the forward and backward model of the phase coded aperture layer.

### Forward Model

The physical imaging process is modeled as a convolution of the aberration free geometrical image with the imaging system PSF. In other words, the final image is the scaled projection of the scene onto the image plane, convolved with the system's PSF, which contains all the system properties: wave aberrations, chromatic aberrations and diffraction effects. Note that in this model, the geometric image is a reproduction of the scene (up to scaling), with no resolution limit. In this model, the PSF calculation contains all the optical properties of the system. The PSF of an incoherent imaging system can be defined as:

PSF=|h_{c}|²=|F{P(ρ,θ)}|², (EQ. 3.1)

where h_{c} is the coherent system impulse response, and P(ρ,θ) is the system's exit pupil function (the amplitude and phase profile in the imaging system exit pupil). The pupil function reference is a perfect spherical wave converging at the image plane. Thus, for an in-focus and aberration free (or diffraction limited) system, the pupil function is just the identity for the amplitude in the active area of the aperture, and zero for the phase.

An imaging system acquiring an object in Out-of-Focus (OOF) conditions suffers from blur that degrades the image quality. This results in low contrast, loss of sharpness and even loss of information. The OOF error can expressed analytically as a quadratic phase wave-front error in the pupil function. In order to quantify the defocus condition, the parameter ψ is introduced. For the case of a circular aperture with radius R, ψ is defined:

$$\begin{matrix}ψ = \frac{π {R}^{2}}{λ} ( \frac{1}{{z}_{o}} + \frac{1}{{z}_{img}} - \frac{1}{f} ) = \frac{π {R}^{2}}{λ} ( \frac{1}{{z}_{img}} - \frac{1}{{z}_{i}} ) \\ = \frac{π {R}^{2}}{λ} ( \frac{1}{{z}_{o}} - \frac{1}{{z}_{n}} ) ,\end{matrix} \qquad ( EQ . 3.2 )$$

where z_{img} is the image distance (or sensor plane location) of an object in the nominal position zₙ, zᵢ is the ideal image plane for an object located at zₒ, and λ is the illumination wavelength. The defocus parameter ψ measures the maximum quadratic phase error at the aperture edge. For a circular pupil:

P_{OOF}=P(ρ,θ)exp{jψρ²}, (EQ. 3.3)

where P_{OOF} is the OOF pupil function, P(ρ,θ) is the in-focus pupil function, and ρ is the normalized pupil coordinate.

The pupil function represents the amplitude and phase profile in the imaging system exit pupil. Therefore, by adding a coded pattern (amplitude, phase, or both) at the exit pupil, the PSF of the system can be manipulated by some pre-designed pattern.

In this case, the pupil function can be expressed as:

P_{CA}=P(ρ,θ)CA(ρ,θ), (EQ. 3.4)

where P_{CA} is the coded aperture pupil function, P(ρ,θ) is the in-focus pupil function, and CA(ρ,θ) is the aperture/phase mask function. The exit pupil is not always accessible. Therefore, the mask of the present embodiments can be added also in the aperture stop, entrance pupil, or in any plane as further detailed hereinabove. In the case of phase coded aperture, CA(ρ,θ) is a circularly symmetric piece-wise constant function representing the phase rings pattern. For simplicity, a single ring phase mask is considered, applying a φ phase shift in a ring starting at r₁ to r₂. Therefore, CA(ρ,θ)=CA(r,φ) where:

$$CA ( r , φ ) = \{ \begin{matrix}exp \{ j φ \} & {r}_{1} < ρ < {r}_{2} \\ 1 & otherwise\end{matrix} \qquad ( EQ . 3.5 )$$

One of ordinarily skill in the art would know how to modify the expression for the case of multiple rings pattern.

Combining all factors, the complete term for the depth dependent coded pupil function becomes:

P(ψ)=P(ρ,θ)CA(r,φ)exp{jψρ²}. (EQ. 3.6)

Using the definition in (EQ. 3.1), the depth dependent coded PSF(ψ) can be calculated.

Using the coded aperture PSF, the imaging output can be calculated by:

Iₒᵤₜ=Iᵢₙ*PSF(ψ). (EQ. 3.7)

This model is a Linear Shift-Invariant (LSI) model. When the PSF varies across the Field of View (FOV), the FOV is optionally and preferably segmented FOV to blocks with similar PSF, and LSI model can be applied to each block.

### Backward Model

The forward model of the phase coded aperture layer is expressed as:

Iₒᵤₜ=Iᵢₙ*PSF(ψ). (EQ. 3.8)

The PSF(ψ) varies with the depth (ψ), but it has also a constant dependence on the phase ring pattern parameters r and φ, as expressed in (3.6). In the network training process, it is preferred to determine both r and φ. Therefore, three separate derivatives are optionally and preferably evaluated: ∂Iₒᵤₜ/∂rᵢ for i=1,2 (the inner and outer radius of the phase ring, as detailed in (6)) and ∂Iₒᵤₜ/∂φ. All three are derived in a similar fashion:

$$\begin{matrix}\frac{\partial {I}_{out}}{\partial {r}_{i} / φ} = \frac{\partial }{\partial {r}_{i} / φ} [ {I}_{in} * PSF ( ψ , r , φ ) ] \\ = {I}_{in} * \frac{\partial }{\partial {r}_{i} / φ} PSF ( ψ , r , φ )\end{matrix} \qquad ( EQ . 3.9 )$$

Thus, it is sufficient to calculate ∂PSF/∂rᵢ and ∂PSF/∂φ. Since both derivatives are almost similar, ∂PSF/∂φ is calculated first, and the differences in the derivation of ∂PSF/∂rᵢ is described later. Using (3.1), one gets:

$$\begin{matrix}\frac{\partial }{\partial φ} PSF ( ψ , r , φ ) = \frac{\partial }{\partial φ} [ ℱ \{ P ( ψ , r , φ ) \overline{ℱ \{ P ( ψ , r , φ )} \} ] \\ = [ \frac{\partial }{\partial φ} ℱ \{ P ( ψ , r , φ ) ] \overline{ℱ \{ P ( ψ , r , φ )} \} ++ \\ ℱ \{ P ( ψ , r , φ ) [ \frac{\partial }{\partial φ} \overline{ℱ \{ P ( ψ , r , φ )} \} ]\end{matrix} \qquad ( EQ . 3.10 )$$

The main term in (3.11) is the derivative of −[F{P(ψ,r,φ)] or its complex conjugate. Due to the linearity of the derivative and the Fourier transform, the order of operations can be reversed and rewritten as:

$$ℱ \{ \frac{\partial }{\partial φ} P ( ψ , r , φ ) \} .$$

Therefore, the last term remaining for calculating the PSF derivative is:

$$\begin{matrix}\frac{\partial }{\partial φ} P ( ψ , r , φ ) = \frac{\partial }{\partial φ} [ P ( ρ , θ ) CA ( r , φ ) exp \{ j {ψρ}^{2} \} ] \\ = P ( ρ , θ ) exp \{ j {ψρ}^{2} \} \frac{\partial }{\partial φ} [ CA ( r , φ ) ] \\ = \{ \begin{matrix}jP ( ψ , r , φ ) & {r}_{1} < ρ < {r}_{2} \\ 0 & otherwise\end{matrix}\end{matrix} \qquad ( EQ . 3.11 )$$

Similar to the derivation of ∂PSF/∂φ, the derivative

$$\frac{\partial }{\partial {r}_{i}} P ( ψ , r , φ )$$

can be used for calculating ∂PSF/∂rᵢ. Similar to (3.11), one have

$$\begin{matrix}\frac{\partial }{\partial {r}_{i}} P ( ψ , r , φ ) = \frac{\partial }{\partial {r}_{i}} [ P ( ρ , θ ) CA ( r , φ ) exp \{ j {ψρ}^{2} \} ] \\ = P ( ρ , θ ) exp \{ j {ψρ}^{2} \} \frac{\partial }{\partial {r}_{i}} [ CA ( r , φ ) ]\end{matrix} \qquad ( EQ . 3.12 )$$

Since the ring radius is a step function, this derivative is optionally and preferably approximated. It was found that tanh(100ρ) achieves sufficiently accurate results for the phase step approximation.

With the full forward and backward model, the phase coded aperture layer can be incorporated as a part of the FCN model, and the phase mask parameters r and φ can be learned along with the network weights.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

E. R. Dowski and W. T. Cathey, “Extended depth of field through wave-front coding,” Appl. Opt. 34, 1859-1866 (1995).
O. Cossairt and S. Nayar, “Spectral focal sweep: Extended depth of field from chromatic aberrations,” in “2010 IEEE International Conference on Computational Photography (ICCP),” (2010), pp. 1-8.
O. Cossairt, C. Zhou, and S. Nayar, “Diffusion coded photography for extended depth of field,” in “ACM SIGGRAPH 2010 Papers,” (ACM, New York, N.Y., USA, 2010), SIGGRAPH '10, pp. 31:1-31:10.
A. Levin, R. Fergus, F. Durand, and W. T. Freeman, “Image and depth from a conventional camera with a coded aperture,” in “ACM SIGGRAPH 2007 Papers,” (ACM, New York, N.Y., USA, 2007), SIGGRAPH '07.
F. Zhou, R. Ye, G. Li, H. Zhang, and D. Wang, “Optimized circularly symmetric phase mask to extend the depth of focus,” J. Opt. Soc. Am. A 26, 1889-1895 (2009).
C. J. R. Sheppard, “Binary phase filters with a maximally-flat response,” Opt. Lett. 36, 1386-1388 (2011).
C. J. Sheppard and S. Mehta, “Three-level filter for increased depth of focus and bessel beam generation,” Opt. Express 20, 27212-27221 (2012).
C. Zhou, S. Lin, and S. K. Nayar, “Coded aperture pairs for depth from defocus and defocus deblurring,” Int. J. Comput. Vis. 93, 53-72 (2011).
R. Raskar, A. Agrawal, and J. Tumblin, “Coded exposure photography: Motion deblurring using fluttered shutter,” in “ACM SIGGRAPH 2006 Papers,” (ACM, New York, N.Y., USA, 2006), SIGGRAPH '06, pp. 795-804.
G. Petschnigg, R. Szeliski, M. Agrawala, M. Cohen, H. Hoppe, and K. Toyama, “Digital photography with flash and no-flash image pairs,” in “ACM SIGGRAPH 2004 Papers,” (ACM, New York, N.Y., USA, 2004), SIGGRAPH '04, pp. 664-672.
H. Haim, A. Bronstein, and E. Marom, “Computational multi-focus imaging combining sparse model with color dependent phase mask,” Opt. Express 23, 24547-24556 (2015).
R. Ng, M. Levoy, M. Brédif, G. Duval, M. Horowitz, and P. Hanrahan, “Light field photography with a hand-held plenoptic camera,” (2005).
H. C. Burger, C. J. Schuler, and S. Harmeling, “Image denoising: Can plain neural networks compete with bm3d?” in “2012 IEEE Conference on Computer Vision and Pattern Recognition,” (2012), pp. 2392-2399.
S. Lefkimmiatis, “Non-local color image denoising with convolutional neural networks,” in “The IEEE Conference on Computer Vision and Pattern Recognition (CVPR),” (2017).
T. Remez, O. Litany, R. Giryes, and A. M. Bronstein, “Deep class-aware image denoising,” in “International Conference on Image Processing (ICIP),” (2017), pp. 138-142.
M. Gharbi, G. Chaurasia, S. Paris, and F. Durand, “Deep joint demosaicking and denoising,” ACM Trans. Graph. 35, 191:1-191:12 (2016).
19. K. Zhang, W. Zuo, S. Gu, and L. Zhang, “Learning deep cnn denoiser prior for image restoration,” in “The IEEE Conference on Computer Vision and Pattern Recognition (CVPR),” (2017).
20. C. Ledig, L. Theis, F. Huszar, J. Caballero, A. P. Aitken, A. Tejani, J. Totz, Z. Wang, and W. Shi, “Photo-realistic single image super-resolution using a generative adversarial network,” 2017 IEEE Conf. on Comput. Vis. Pattern Recognit. (CVPR) pp. 105-114 (2017).
N. K. Kalantari and R. Ramamoorthi, “Deep high dynamic range imaging of dynamic scenes,” ACM Trans. Graph. 36, 144:1-144:12 (2017).
J. O.-C. neda and C. M. Gómez-Sarabia, “Tuning field depth at high resolution by pupil engineering,” Adv. Opt. Photon. 7, 814-880 (2015).
E. E. García-Guerrero, E. R. Méndez, H. M. Escamilla, T. A. Leskova, and A. A. Maradudin, “Design and fabrication of random phase diffusers for extending the depth of focus,” Opt. Express 15, 910-923 (2007).
F. Guichard, H.-P. Nguyen, R. TessiÃĺres, M. Pyanet, I. Tarchouna, and F. Cao, “Extended depth-of-field using sharpness transport across color channels,” in “Proc. SPIE,”, vol. 7250 (2009), vol. 7250, pp. 7250-7250-12.
A. Chakrabarti, “Learning sensor multiplexing design through back-propagation,” in “Advances in Neural Information Processing Systems 29,” D. D. Lee, M. Sugiyama, U. V. Luxburg, I. Guyon, and R. Garnett, eds. (Curran Associates, Inc., 2016), pp. 3081-3089.
H. G. Chen, S. Jayasuriya, J. Yang, J. Stephen, S. Sivaramakrishnan, A. Veeraraghavan, and A. C. Molnar, “Asp vision: Optically computing the first layer of convolutional neural networks using angle sensitive pixels,” 2016 IEEE Conf. on Comput. Vis. Pattern Recognit. (CVPR) pp. 903-912 (2016).
G. Satat, M. Tancik, O. Gupta, B. Heshmat, and R. Raskar, “Object classification through scattering media with deep learning on time resolved measurement,” Opt. Express 25, 17466-17479 (2017).
M. Iliadis, L. Spinoulas, and A. K. Katsaggelos, “Deepbinarymask: Learning a binary mask for video compressive sensing,” CoRR abs/1607.03343 (2016).
B. Milgrom, N. Konforti, M. A. Golub, and E. Marom, “Novel approach for extending the depth of field of barcode decoders by using rgb channels of information,” Opt. express 18, 17027-17039 (2010).
E. Ben-Eliezer, N. Konforti, B. Milgrom, and E. Marom, “An optimal binary amplitude-phase mask for hybrid imaging systems that exhibit high resolution and extended depth of field,” Opt. Express 16, 20540-20561 (2008).
S. Ryu and C. Joo, “Design of binary phase filters for depth-of-focus extension via binarization of axisymmetric aberrations,” Opt. Express 25, 30312-30326 (2017).
J. Goodman, Introduction to Fourier Optics (MaGraw-Hill, 1996), 2nd ed.
D. E. Rumelhart, G. E. Hinton, and R. J. Williams, “Learning representations by back-propagating errors,” Nature 323, 533-536 (1986).
M. Cimpoi, S. Maji, I. Kokkinos, S. Mohamed, and A. Vedaldi, “Describing textures in the wild,” in “Proceedings of the IEEE Conf. on Computer Vision and Pattern Recognition (CVPR),” (2014).
H. Zhao, O. Gallo, I. Frosio, and J. Kautz, “Loss functions for image restoration with neural networks,” IEEE Transactions on Comput. Imaging 3, 47-57 (2017).
Y. Ma and V. N. Borovytsky, “Design of a 16.5 megapixel camera lens for a mobile phone,” OALib 2, 1-9 (2015).
D. Krishnan, T. Tay, and R. Fergus, “Blind deconvolution using a normalized sparsity measure,” in “CVPR 2011,” (2011), pp. 233-240.
J. Mairal, F. Bach, J. Ponce, and G. Sapiro., “Online learning for matrix factorization and sparse coding,” J. Mach. Learn. Res. 11, 19-60 (2010).
A. Vedaldi and K. Lenc, “Matconvnet—convolutional neural networks for matlab,” in “Proceeding of the ACM Int. Conf. on Multimedia,” (2015), pp. 689-692.
Y. Cao, Z. Wu, and C. Shen, “Estimating depth from monocular images as classification using deep fully convolutional residual networks,” CoRR, vol. abs/1605.02305, 2016. [Online]. Available: arxivDOTorg/abs/1605.02305
D. Eigen, C. Puhrsch, and R. Fergus, “Depth map prediction from a single image using a multi-scale deep network,” in Advances in Neural Information Processing Systems 27, Z. Ghahramani, M. Welling, C. Cortes, N. D. Lawrence, and K. Q. Weinberger, Eds. Curran Associates, Inc., 2014, pp. 2366-2374. [Online]. Available: papersDOTnipsDOTcc/paper/5539-depth-map-prediction-from-a-single-image-using-a-multi-scale-deep-network.pdf
C. Godard, O. Mac Aodha, and G. J. Brostow, “Unsupervised monocular depth estimation with left-right consistency,” CoRR, vol. abs/1609.03677, 2016. [Online]. Available: arxivDOTorg/abs/1609.03677
H. Jung and K. Sohn, “Single image depth estimation with integration of parametric learning and non-parametric sampling,” Journal of Korea Multimedia Society, vol. 9, no. 9, September 2016. [Online]. Available: dxDOTdoiDOTorg/10.9717/kmms.2016.19.9.1659
I. Laina, C. Rupprecht, V. Belagiannis, F. Tombari, and N. Navab, “Deeper depth prediction with fully convolutional residual networks,” CoRR, vol. abs/1606.00373, 2016. [Online]. Available: arxivDOTorg/abs/1606.00373
F. Liu, C. Shen, G. Lin, and I. Reid, “Learning depth from single monocular images using deep convolutional neural fields,” IEEE Transactions on Pattern Analysis and Machine Intelligence, 2016. [Online]. Available: dxDOTdoiDOTorg/10.1109/TPAMI.2015.2505283
J. Long, E. Shelhamer, and T. Darrell, “Fully convolutional networks for semantic segmentation,” CVPR, November 2015.
K. He, X. Zhang, S. Ren, and J. Sun, “Deep residual learning for image recognition,” in The IEEE Conference on Computer Vision and Pattern Recognition (CVPR), June 2016.
P. K. Nathan Silberman, Derek Hoiem and R. Fergus, “Indoor segmentation and support inference from rgbd images,” in ECCV, 2012.
N. Silberman and R. Fergus, “Indoor scene segmentation using a structured light sensor,” in Proceedings of the International Conference on Computer Vision—Workshop on 3D Representation and Recognition, 2011.
A. Saxena, M. Sun, and A. Y. Ng, “Make3d: Learning 3d scene structure from a single still image,” IEEE Trans. Pattern Anal. Mach. Intell., vol. 31, no. 5, pp. 824-840, May 2009. [Online]. Available: dxDOTdoiDOTorg/10.1109/TPAMI.2008.132
E. R. Dowski and W. T. Cathey, “Extended depth of field through wave-front coding,” Applied Optics, vol. 34, no. 11, pp. 1859-1866, 1995.
O. Cossairt, C. Zhou, and S. Nayar, “Diffusion coded photography for extended depth of field,” in ACM Transactions on Graphics (TOG), vol. 29, no. 4. ACM, 2010, p. 31.
H. Nagahara, S. Kuthirummal, C. Zhou, and S. K. Nayar, “Flexible depth of field photography,” in Computer Vision-ECCV 2008. Springer, 2008, pp. 60-73.
O. Cossairt and S. Nayar, “Spectral focal sweep: Extended depth of field from chromatic aberrations,” in Computational Photography (ICCP), 2010 IEEE International Conference on. IEEE, 2010, pp. 1-8.
A. Levin, R. Fergus, F. Durand, and W. T. Freeman, “Image and depth from a conventional camera with a coded aperture,” ACM Transactions on Graphics, vol. 26, no. 3, p. 70, 2007.
A. Chakrabarti and T. Zickler, “Depth and deblurring from a spectrally-varying depth-of-field,” in Computer Vision-ECCV 2012. Springer, 2012, pp. 648-661.
M. Martinello, A. Wajs, S. Quan, H. Lee, C. Lim, T. Woo, W. Lee, S.-S. Kim, and D. Lee, “Dual aperture photography: Image and depth from a mobile camera,” April 2015.
B. Milgrom, N. Konforti, M. A. Golub, and E. Marom, “Novel approach for extending the depth of field of barcode decoders by using rgb channels of information,” Optics express, vol. 18, no. 16, pp. 17027-17039, 2010.
H. Haim, A. Bronstein, and E. Marom, “Computational multi-focus imaging combining sparse model with color dependent phase mask,” Opt. Express, vol. 23, no. 19, pp. 24547-24556, September 2015. [Online]. Available: wwwDOTopticsexpressDOTorg/abstract.cfm?URI=oe-23-19-24547
J. Goodman, Introduction to Fourier Optics, 2nd ed. MaGraw-Hill, 1996.
G. Huang, Z. Liu, L. van der Maaten, and K. Q. Weinberger, “Densely connected convolutional networks,” in The IEEE Conference on Computer Vision and Pattern Recognition (CVPR), July 2017.
S. Ioffe and C. Szegedy, “Batch normalization: Accelerating deep network training by reducing internal covariate shift,” in Proceedings of the 32nd International Conference on Machine Learning (ICML-15), D. Blei and F. Bach, Eds. JMLR Workshop and Conference Proceedings, 2015, pp. 448-456. [Online]. Available: jmlrDOTorg/proceedings/papers/v37/ioffe15.pdf
A. Krizhevsky, I. Sutskever, and G. E. Hinton, “Imagenet classification with deep convolutional neural networks,” in Advances in Neural Information Processing Systems 25, F. Pereira, C. J. C. Burges, L. Bottou, and K. Q. Weinberger, Eds. Curran Associates, Inc., 2012, pp. 1097-1105. [Online]. Available: papersDOTnipsDOTcc/paper/4824-imagenet-classification-with-deep-convolutional-neural-networks.pdf
J. T. Springenberg, A. Dosovitskiy, T. Brox, and M. A. Riedmiller, “Striving for simplicity: The all convolutional net.” CoRR, vol. abs/1412.6806, 2014. [Online]. Available: dblpDOTuni-trier.de/db/journals/corr/corr1412.html#SpringenbergDBR14
M. Cimpoi, S. Maji, I. Kokkinos, S. Mohamed, and A. Vedaldi, “Describing textures in the wild,” in Proceedings of the IEEE Conf. on Computer Vision and Pattern Recognition (CVPR), 2014.
D. J. Butler, J. Wulff, G. B. Stanley, and M. J. Black, “A naturalistic open source movie for optical flow evaluation,” in European Conf. on Computer Vision (ECCV), ser. Part IV, LNCS 7577, A. Fitzgibbon et al. (Eds.), Ed. Springer-Verlag, October 2012, pp. 611-625.

What is claimed is:

1. A method of designing an element for the manipulation of waves, the method comprising:
accessing a computer readable medium storing a machine learning procedure, having a plurality of learnable weight parameters, wherein a first plurality of said weight parameters corresponds to the element, and a second plurality of said weight parameters correspond to an image processing;
accessing a computer readable medium storing training imaging data;
training said machine learning procedure on said training imaging data, so as to obtain values for at least said first plurality of said weight parameters.

2. The method according to claim 1, wherein the element is a phase mask having a ring pattern, and wherein said first plurality of said weight parameters comprises a radius parameter and a phase-related parameter.

3. The method according to claim 1, wherein said training comprises using backpropagation.

4. The method according to claim 3, wherein said backpropagation comprises calculation of derivatives of a point spread function (PSF) with respect to each of said first plurality of said weight parameters.

5. The method according to claim 1, wherein said training comprises training said machine learning procedure to focus an image.

6. The method according to claim 5, wherein said machine learning procedure comprises a convolutional neural network (CNN).

7. The method according to claim 6, wherein said CNN comprises an input layer configured for receiving said image and an out-of-focus condition.

8. The method according to claim 6, wherein said CNN comprises a plurality of layers, each characterized by a convolution dilation parameter, and wherein values of said convolution dilation parameters vary gradually and non-monotonically from one layer to another.

9. The method according to claim 6, wherein said CNN comprises a skip connection of said image to an output layer of said CNN, such that said training comprises training said CNN to compute de-blurring corrections to said image without computing said image.

10. The method according to claim 1, wherein said training comprises training said machine learning procedure to generate a depth map of an image.

11. The method according to claim 10, wherein said depth map is based on depth cues introduced by the element.

12. The method according to claim 10, wherein said machine learning procedure comprises a depth estimation network and a multi-resolution network.

13. The method according to claim 12, wherein said depth estimation network comprises a convolutional neural network (CNN).

14. The method according to claim 12, wherein said multi-resolution network comprises a fully convolutional neural network (FCN).

15. A computer software product, comprising a computer-readable medium in which program instructions are stored, wherein said instructions, when read by an image processor, cause the image processor to execute the method according to claim 1.

16. A method of fabricating an element for manipulating waves, the method comprising, executing the method according to claim 1, and fabricating the element according to said first plurality of said weight parameters.

17. An element producible by a method according to claim 16.

18. An imaging system, comprising the element according to claim 17.

19. A portable device, comprising the imaging system of claim 18.

20. The portable device of claim 19, being selected from the group consisting of a cellular phone, a smartphone, a tablet device, a mobile digital camera, a wearable camera, a personal computer, a laptop, a portable media player, a portable gaming device, a portable digital assistant device, a drone, and a portable navigation device.

21. A method of imaging, comprising:
capturing an image of a scene using an imaging device having a lens and an optical mask placed in front of said lens, said optical mask comprising the element according to claim 17; and
processing said image using an image processor to de-blur said image and/or to generate a depth map of said image.

22. The method according to claim 21, wherein said processing is by a trained machine learning procedure.

23. The method according to claim 21, wherein said processing is by a procedure selected from the group consisting of sparse representation, blind deconvolution, and clustering.

24. The method according to claim 21, being executed for providing augmented reality or virtual reality.

25. The method according to claim 21, wherein said scene is a production or fabrication line of a product.

26. The method according to claim 21, wherein said scene is an agricultural scene.

27. The method according to claim 21, wherein said scene comprises an organ of a living subject.

28. The method according to claim 21, wherein said imaging device comprises a microscope.
